(19) United States
(12) Patent Application Publication
(10) Pub. No.: US 2020/0092514 A1
(43) Pub. Date: Mar. 19, 2020

(54) Video Insert Control

(71) Applicant: Telefonaktiebolaget LM Ericsson (Publ), Stockholm (SE)

(72) Inventor: Francis QUIERS, Buckinghamshire (GB)

(21) Appl. No.: 16/467,336

(22) PCT Filed: Dec. 9, 2016
(86) PCT No.: PCT/EP2016/080526

§ 371 Date: Jun. 6, 2019

(51) Int. Cl. H04N 5/57; H04N 21/44; H04N 21/81; H04N 21/8547; H04N 21/234

(52) U.S. Cl. CPC H04N 5/57; H04N 21/44016; H04N 21/23424; H04N 21/8547; H04N 21/812

(57) ABSTRACT

A program brightness metric representing a current brightness of a video program is determined. A corresponding insert brightness metric representing a current brightness of a video insert to be spliced into the video program during an ongoing video session is also determined. A decision whether to adjust brightness of at least an initial portion of decoded pictures of the video insert is made based on the program brightness metric and the insert brightness metric. Accordingly, a smooth transition between video programs and video inserts, such as advertisements, is enabled.

### TECHNICAL FIELD

The present embodiments generally relate to video insert control.

### BACKGROUND

A major source of revenue in the domain of broadcast television (TV) lies in commercial advertising. With broadcast systems and end-user equipment offering an ever-improving experience in terms of picture and sound quality, choice of contents, on-demand services etc., the potential value of advertisement keeps growing to more considerable amounts every year. In particular, one method that is used as an attempt to increase the impact of advertisement on viewers is the move from centralized adverts insertion at the headend of the broadcasters, to localized or personalized adverts insertion at the viewers' own receiving equipment, such as their set-top box (STB). Various systems of this kind, often based on the American National Standards Institute/Society of Cable Telecommunications Engineers 35 (ANSI/SCTE 35) standard, have been described, for instance in U.S. Pat. No. 8,997,142.

At the same time, technology advances over the recent years mean that viewers now use higher fidelity and more powerful equipment than in the past. Particularly, the development of Ultra-High Definition (UHD) television is bringing larger screens to the living-room, with High Dynamic Range (HDR) to allow the rendering of much darker and brighter scenes than ever before. The audio experience is also constantly improving, with home theaters and sound bars providing surround sound that becomes more and more realistic and immersive.

While television is constantly evolving towards a more cinema-like experience, a major difference remains in terms of the presence of commercial breaks interrupting long programs, such as movies, documentaries or sports games, particularly on pay-TV channels for which it is a major part of the business model. From the viewer's perspective, such interruptions may at times feel quite disruptive, particularly when the viewer is immersed within a particular program with a strong story line, such as for example a movie or sports game. Even if the video inserts, i.e., digital program inserts, such as adverts, have been chosen by the broadcaster and their partners to be as relevant to the viewer as possible, for example based on the type of content being interrupted, or the regional geographical area, it is likely that the transition between the main program and the adverts will come across as an unexpected and artificial change of context. When this is the case, the adverts become less effective, if not entirely ignored by the user who might decide to change channel until the adverts break is over.

Thus, there is a need for efficient control of adverts and other video inserts spliced into video programs, and in particular such a control that increases the user experience of the adverts insertion.

### SUMMARY

It is an objective to enable further control of transitions between video programs and video inserts during an ongoing video session.

This and other objectives are met by embodiments disclosed herein.

An aspect of the embodiments relates to a video insert control method comprising determining a program brightness metric of a video program. The program brightness metric represents a current brightness of the video program. The video insert control method also comprises determining an insert brightness metric of a video insert. The insert brightness metric represents a current brightness of the video insert to be spliced into the video program during an ongoing video session. The video insert control method further comprises deciding whether to adjust brightness of at least an initial portion of decoded pictures of the video insert based on the program brightness metric and the insert brightness metric.

Another aspect of the embodiments relates to a brightness control method. The brightness control method comprises receiving a bitstream comprising encoded pictures of a video program and encoded pictures of a video insert. The method also comprises retrieving, from the bitstream and for at least an initial portion of encoded pictures of the video insert, brightness control data representing a brightness adjustment. The brightness control method further comprises decoding encoded pictures of the video program and encoded pictures of the video insert. The brightness control method additionally comprises adjusting brightness of at least an initial portion of decoded pictures of the video insert based on the brightness control data.

A further aspect of the embodiments relates to a video insert control device. The video insert control device is configured to determine a program brightness metric of a video program. The program brightness metric represents a current brightness of the video program. The video insert control device is also configured to determine an insert brightness metric of a video insert. The insert brightness metric represents a current brightness of the video insert to be spliced into the video program during an ongoing video session. The video insert control device is further configured to decide whether to adjust brightness of at least an initial portion of decoded pictures of the video insert based on the program brightness metric and the insert brightness metric.

Yet another aspect of the embodiments relates to a video insert control device comprising a program metric determining module for determining a program brightness metric of a video program. The program brightness metric represents a current brightness of the video program. The video insert control device also comprises an insert metric determining module for determining an insert brightness metric of a video insert. The insert brightness metric represents a current brightness of the video insert to be spliced into the video program during an ongoing video session. The video insert control device further comprises a deciding module for deciding whether to adjust brightness of at least an initial portion of decoded pictures of the video insert based on the program brightness metric and the insert brightness metric.

A further aspect of the embodiments relates to a set-top-box comprising a video decoder configured to retrieve, from a received bitstream comprising encoded pictures of a video program and encoded pictures of a video insert and for at least an initial portion of encoded pictures of said video insert, brightness control data representing a brightness adjustment and decode encoded pictures of the video program and encoded pictures of the video insert. The set-top box also comprises a brightness controller configured to adjust a brightness of at least an initial portion of decoded pictures of the video insert based on the brightness control data.

Another aspect of the embodiments relates to a computer program comprising instructions, which when executed by at least one processor, cause the at least one processor to determine a program brightness metric of a video program. The program brightness metric represents a current brightness of the video program. The at least one processor is also caused to determine an insert brightness metric of a video insert. The insert brightness metric represents a current brightness of the video insert to be spliced into the video program during an ongoing video session. The at least one processor is further caused to decide whether to adjust brightness of at least an initial portion of decoded pictures of the video insert based on the program brightness metric and the insert brightness metric.

Yet another aspect of the embodiments relates to a computer program comprising instructions, which when executed by at least one processor, cause the at least one processor to retrieve, from a received bitstream comprising encoded pictures of a video program and encoded pictures of a video insert and for at least an initial portion of encoded pictures of the video insert, brightness control data representing a brightness adjustment. The at least one processor is also caused to decode encoded pictures of the video program and encoded pictures of the video insert. The at least one processor is further caused to adjust a brightness of at least an initial portion of decoded pictures of the video insert based on the brightness control data.

A further aspect of the embodiments relates to a carrier comprising a computer program as defined above. The carrier is one of an electronic signal, an optical signal, an electromagnetic signal, a magnetic signal, an electric signal, a radio signal, a microwave signal, or a computer-readable storage medium.

The embodiments achieve a smooth transition between a video program, such as a movie, and video inserts spliced into the video program during an ongoing video session. This smooth transition is achieved by adjusting, where necessary, the brightness of a least an initial portion of the video insert to better match the brightness of at least a portion of the video program and thereby increase the user experience during such transitions.

### BRIEF DESCRIPTION OF THE DRAWINGS

The embodiments, together with further objects and advantages thereof, may best be understood by making reference to the following description taken together with the accompanying drawings, in which:

FIG. 1 is a flow chart illustrating a video insert control method according to an embodiment;

FIG. 2 is a flow chart illustrating an additional, optional step of the video insert control method shown in FIG. 1 according to an embodiment;

FIG. 3 is a flow chart illustrating additional, optional steps of the video insert control method shown in FIG. 1 according to an embodiment;

FIG. 4 is a flow chart illustrating an embodiment of the deciding step in FIG. 1 according to an embodiment;

FIG. 5 is a flow chart illustrating another embodiment of the deciding step in FIG. 1 according to an embodiment;

FIG. 6 is a flow chart illustrating additional, optional steps of the video insert control method shown in FIG. 1 according to another embodiment;

FIG. 7 is a flow chart illustrating additional, optional steps of the video insert control method shown in FIG. 1 according to a further embodiment;

FIG. 8 is a flow chart illustrating additional, optional steps of the video insert control method shown in FIG. 1 according to yet another embodiment;

FIG. 9 is a flow chart illustrating a brightness control method according to an embodiment;

FIG. 10 schematically illustrates a video insert spliced into a video program;

FIG. 11 schematically illustrates an STB according to an embodiment;

FIG. 12 is a flow chart illustrating operation of a splicer in the STB shown in FIG. 11 according to an embodiment;

FIG. 13 is a flow chart illustrating operation of a brightness and loudness estimator in the STB shown in FIG. 11 according to an embodiment;

FIG. 14 is a flow chart illustrating operation of a brightness and loudness controller in the STB shown in FIG. 11 according to an embodiment;

FIG. 15 schematically illustrates a video service provider and an STB according to an embodiment;

FIG. 16 is a schematic block diagram of a video insert control device according to an embodiment;

FIG. 17 is a schematic block diagram of a video insert control device according to another embodiment;

FIG. 18 is a schematic block diagram of a video insert control device according to a further embodiment;

FIG. 19 is a schematic block diagram of a computer program based implementation of an embodiment;

FIG. 20 is a schematic block diagram of a video insert control device according to yet another embodiment;

FIG. 21 is a schematic block diagram of an STB according to another embodiment;

FIG. 22 is a schematic block diagram of a video service provider according to another embodiment; and

FIG. 23 schematically illustrates a distributed implementation among multiple network devices; and

FIG. 24 is a schematic illustration of an example of a wireless communication system with one or more cloud-based network devices according to an embodiment.

### DETAILED DESCRIPTION

Throughout the drawings, the same reference numbers are used for similar or corresponding elements.

The present embodiments generally relate to video insert control, and in particular to controlling brightness of a video insert.

Digital program insertion (DPI) allows video service providers, such as cable headends and broadcast affiliates, to insert or splice video inserts, also referred to as digital program inserts in the art, into remotely distributed video programs. The video inserts may, for instance, be locally generated commercials and adverts or short programs that are inserted in, i.e., spliced into, the video program either before they are delivered to the STBs or video players of the users, or are inserted locally in the users' STBs or video players.

Such video inserts are a major source of revenue for the video service providers. However, such video inserts causing interruptions in the video program may, from the viewer's perspective, at times feel quite disruptive, particularly when the viewer is immersed within a particular video program with a strong story line, such as for example a movie or a sports game. Even if the adverts have been chosen by the broadcaster and their partners to be as relevant to the viewer as possible, for example based on the type of content being interrupted, or the regional geographical area, it is likely that the transition between the video program and the adverts will come across as an unexpected and artificial change of context, quite possibly accompanied by a sudden change in brightness, loudness, or both.

The transitions from the video program to a video insert may be even more prominent with the development of UHD television, bringing larger screens to the living-room, and with HDR, allowing the rendering of much darker and brighter scenes than ever before. Thus, there may be large differences in brightness between the video program and the video insert, such as between a dark movie scene and a very bright video insert. Such a transition is likely to upset the viewer, particularly if the viewer has chosen not to use an ambient lighting system as part of their television viewing environment, but prefer a darker room like that of a cinema. Moreover, newer technologies like HDR will make it possible for advertisers to produce content with a much higher level of brightness than ever before, making such transitions even more disruptive to the viewer.

The present embodiments solve or at least reduce the problem with the prior art technology by enabling a further control of transition between a video program and a video insert, such as by achieving a smoother transition between the video program and the video insert. This is possible by monitoring the brightness of the video program and the video insert and then deciding whether to adjust the brightness of at least an initial portion of the video insert to reduce large brightness steps in connection with transitions from the video program to the video insert.

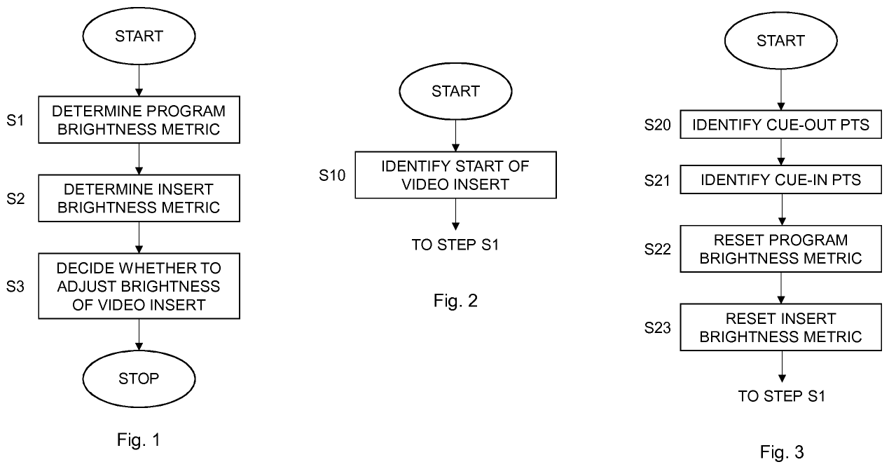

FIG. 1 is a flow chart illustrating a video insert control method according to an embodiment. The video insert control method comprises determining, in step S1, a program brightness metric of a video program. The program brightness metric represents a current brightness of the video program. The video insert control method also comprises determining, in step S2, an insert brightness metric of a video insert. The insert brightness metric represents a current brightness of the video insert to be spliced into the video program during an ongoing video session. A following step S3 comprises deciding whether to adjust brightness of at least an initial portion of decoded pictures of the video insert based on the program brightness metric and the insert brightness metric.

The video insert control method thereby comprises determining, or estimating, two so-called brightness metrics, one for the video program, i.e., the program brightness metric, and one of the video insert, i.e., the insert brightness metric. These brightness metrics represent the current brightness of the video program and the video insert, respectively. Current brightness as used herein indicates the brightness of a current or latest portion of the video program or the video insert.

For instance, the current brightness could represent the brightness of a time window, such as of the latest τ seconds of video for some defined value of τ. Thus, in an embodiment, the program brightness metric preferably represents the brightness of a current or latest τₚ seconds of the video program, for some defined value of τₚ. Correspondingly, the insert brightness metric preferably represents the brightness of a current or initial τᵢ seconds of the video insert, for some defined value of τᵢ. In such an embodiment, τₚ could be equal to τᵢ. Alternatively, τₚ is different from τᵢ, such as larger than τᵢ.

In a particular embodiment, the program brightness metric represents the brightness of a portion of the video program immediately prior to start of the video insert, for instance the brightness of the τₚ seconds of the video program immediately prior to the start of the video insert. In this particular embodiment, the insert brightness metric correspondingly represents the brightness of an initial portion of the video insert immediately following the start of the video insert, for instance the brightness of the τᵢ seconds of the video insert immediately following the start of the video insert.

Typically, but non-limiting, examples of the values of τₚ and τᵢ are 3 to 30 s, preferably 3 to 20 s, more preferably 3 to 10 s, such as 3 to 7 s, for instance 5 s for τₚ and 0.5 to 10 s, preferably 0.5 to 5 s, more preferably 1 to 3 s, such as 2 s for τᵢ.

The program and insert brightness metrics could be calculated as the average brightness of pictures within the τₚ s of the video program or the τᵢ s of the video insert, respectively. Alternative brightness metrics could be median, maximum or minimum brightness of pictures within the τₚ or τᵢ s of the video program or video insert.

In an alternative approach, a weighted average is calculated instead of a simple average. In such a case, the weights for the pictures of the video program preferably increase the closer to the start of the video insert. For instance, assume that the video insert starts at picture index, such as picture output count (POC) value, k+1. In such a case, the last picture of the video program prior to the start of the video insert has picture index, such as POC value, k. In this embodiment, the brightness weight wₖ for the last picture of the video program prior to the start of the video insert is preferably larger than the brightness weight wₖ₋₁ for the second last picture of the video program prior to the start of the video start, and so forth.

Correspondingly, the weights for the pictures of the video insert preferably decrease the farther from the start of the video insert. In such a case, the brightness weight wₖ₊₁ of the first picture of the video insert following start of the video start is preferably larger than the brightness weight wₖ₊₂ for the second picture of the video insert, and so forth.

In an embodiment, step S1 of FIG. 1 comprises updating the program brightness metric based on a current picture of the video program. The program brightness metric is a rolling brightness metric representing the current brightness of the video program. Step S2 correspondingly comprises, in this embodiment, updating the insert brightness metric based on a current picture of the video insert. The insert brightness metric is a rolling brightness metric representing the current brightness of the video insert.

In this embodiment, the video and insert brightness metrics are rolling metrics that are updated once a current picture of the video program or video insert is available. In this embodiment, the brightness metrics are thereby updated preferably each and every time a new picture of the video program or a new picture of the video insert is available. This means that the brightness metrics will represent the current brightness of the video program or the video insert through the updating of the metrics based on brightness values of current pictures.

The brightness of a picture, either of the video program or of the video insert, could be any brightness representing parameter indicative of the brightness of the picture. For instance, brightness of a picture could be average brightness of the picture, median brightness of the picture, maximum brightness of the picture or minimum brightness of the picture.

The pixels or samples of pictures generally have pixel or sample values representing a color of the pixels or samples. There are different color spaces or color formats used in the art of video coding. Generally, a raw video, i.e., prior to encoding, decoding and other forms of video processing, is in the RGB color space, i.e., having a red (R) color value, a green (G) color value and a blue (B) color value. The RGB values of the pixels of a picture are typically converted into the so-called luma (Y′)+chroma (Cb, Cr) values in the Y′CbCr color space prior to encoding. The conversion involves using a transfer function to go from a RGB value into a R′G′B′ value and a color transform from the R′G′B′ value into a Y′CbCr value.

Other color spaces that are commonly used within video coding and presentation is the luminance (Y)+chrominance (X, Z) values in the XYZ color space. An XYZ value can be obtained by applying a color transform to a RGB value. A further color space used for video is the lightness (L*)+color (a*, b*) values in the CIE L*a*b* color space, also referred to as the Lab color space. An L*a*b* value can be obtained from an XYZ value.

Brightness as used herein could be any brightness representing parameter regardless of the color space of the picture. For instance, if the pictures are in the Y′CbCr color space, the brightness of a picture could be a luma value Y′, such as the average, median, maximum or minimum Y′ value of the picture. If the pictures are in the XYZ color space, the brightness of a picture could be a luminance value Y, such as the average, median, maximum or minimum Y value of the picture. Correspondingly, if the pictures are in the RGB color space, the brightness of a picture could be an average or weighted average of the R, G, B values, such as the average or weighted average of the average, median, maximum or minimum RGB value of the picture. In this latter case, the brightness is thereby calculated as (R+G+B)/3 or (w_{R}R+w_{G}G+w_{B}B)/3, wherein w_{R}+w_{G}+w_{B}=1. The weighted average could be preferred in some embodiments since different color channels R, G, B generally have a different contribution to what the human visual system regards as brightness. If the pictures are in the L*a*b* color space, the brightness of a picture could be a lightness value L*, such as the average, median, maximum or minimum L* value of the picture.

In a particular embodiment, step S1 of FIG. 1 comprises calculating the program brightness metric Bₑₛₜ^{p}(t) based on Bₑₛₜ^{p}(t)=αₚBₚ(t)+(1−αₚ)Bₑₛₜ^{p}(t−1). In this particular embodiment, αₚ is a smoothing factor that depends on a picture rate rₚ of the video program and a time constant τₚ, and Bₚ (t) is a brightness representing parameter of a current picture of the video program. Step S2 comprises, in this particular embodiment, calculating the insert brightness metric Bₑₛₜⁱ(t) based on Bₑₛₜⁱ(t)=αᵢBᵢ(t)+(1−αᵢ)Bₑₛₜⁱ(t−1). In this particular embodiment, αᵢ is a smoothing factor that depends on a picture rate rᵢ of the video insert and a time constant τᵢ, and Bᵢ (t) is a brightness representing parameter of a current picture of the video insert, wherein τᵢ≤τₚ.

Any smoothing factor that depends on the picture rate and a time constant could be used in the above described embodiment to reduce the impact of instantaneous variations in brightness between consecutive pictures and provide a brightness metric that better represents what the human visual system, including its memory, perceives as the short-term to medium-term brightness.

In a particular embodiment, the smoothing factors could be selected to obtain exponentially smoothed brightness metrics. An example of such a particular embodiment is to use the following smoothing factors

$${α}_{p} = 1 - {e}^{- \frac{1}{{r}_{p} {τ}_{p}}} and {α}_{i} = 1 - {e}^{- \frac{1}{{r}_{i} {τ}_{i}}} .$$

In another particular embodiment, step S1 of FIG. 1 comprises calculating the program brightness metric Bₑₛₜ^{p}(t) based on Bₑₛₜ^{p}(t)=max_{k=0 . . . n}_{ₚ}₋₁(Bₚ(t−k)). In this particular embodiment, nₚ is a parameter that depends on a picture rate τₚ of the video program and a time constant τₚ, and Bₚ(t) is a brightness representing parameter of a current picture of the video program. Step S2 comprises, in this particular embodiment, calculating the insert brightness metric Bₑₛₜⁱ(t) based on Bₑₛₜⁱ(t)=max_{k=0 . . . n}_{ᵢ}₋₁(Bᵢ(t−k)). In this particular embodiment, nᵢ is a parameter that depends on a picture rate rᵢ of the video insert and a time constant τᵢ, and Bᵢ (t) is a brightness representing parameter of a current picture of the video insert, wherein τᵢ≤τₚ.

This particular embodiment is based on the maximum follower approach, in which the brightness metric is the maximum brightness value over a time window of past inputs, i.e., brightness representations of past pictures. An advantage of this particular embodiment is that it could provide better tracking of peaks in brightness over the past few seconds worth of pictures, and therefore constitute a more representative model to what the user may perceive based on the memory characteristics of his/her visual system.

The parameters nₚ and nᵢ could be any parameter that depends on the picture rate and the time constant. In an example of this particular embodiment, nₚ=rₚ×τₚ and nᵢ=rᵢ×τᵢ.

The time constants τₚ and τᵢ represent the time window within which the calculations of the program and insert brightness metrics are calculated in steps S1 and S2. As mentioned in the foregoing, the two time constants and windows could be equal. However, it is generally preferred if τᵢ<τₚ. Non-limiting, but illustrative, values of the time constants have been presented in the foregoing.

FIG. 2 is a flow chart illustrating an additional, optional step of the video insert control method shown in FIG. 1. The video insert control method starts in step S10, which comprises identifying a start of the video insert during the ongoing video session. The video insert control method then continues to step S1 in FIG. 1. In this embodiment, step S2 comprises initiating determination of the insert brightness metric at the start of said video insert.

Thus, once the start of the video insert has been identified the determination of the insert brightness metric can be initiated at the start of the video insert. In an embodiment, the start of the video insert also indicates the end of this part of the video program, which then is typically continued at the end of the video insert. Thus, the start of the video insert preferably also indicates the stop or end point for determining or updating the program brightness metric.

Thus, the brightness of pictures prior to the start of the video insert is preferably used to determine or update the program brightness metric and the brightness of at least the pictures immediately following the start of the video insert is preferably used to determine or update the insert brightness metric.

There are various embodiments of identifying the start of the video insert. In an embodiment, each picture of the video session, regardless of being a picture of the video program or a picture of a video insert, is assigned a presentation time stamp (PTS) value. In a typical case, the PTS values of the pictures are increasing for each picture up to a maximum value and then started over again. In such a case, the start of the video insert can be identified based on the PTS values.

Within the art of DPI, so-called splice points or splice events indicate the point at which a video insert is inserted or spliced into a video program and indicate the point at which the video insert ends and the video program once more continues. The former splice points, i.e., going from video program to video insert, are denoted cue-out splice points or splice events, and are sometimes referred to as out-of-network splice points, and the latter splice points, i.e., going from video insert to video program, are denoted cue-in splice points or splice events, and are sometimes referred to as return-to-network splice points. FIG. 10 schematically illustrates this concept of cue-out and cue-in splice events. Such cue-out and cue-in splice events may be indicated by indicators, typically denoted out_of_network_indicator in the art. For instance, an out_of_network_indicator value of 1 could indicate a cue-out splice event, whereas an out_of_network_indicator value of 0 could indicate a cue-in splice event.

The PTS values of the cue-out and cue-in splice points or events are listed in a so-called splice information table. This means that the splice information table may contain information of the PTS values of all splice events together with an indication of whether a splice event is a cue-out or a cue-in splice event. The information contained in the splice information table can thereby be used in order to identify the start of the video insert.

Hence, in an embodiment step S10 of FIG. 2 is performed as shown in step S20 of FIG. 3. This step S20 comprises identifying a PTS value of a splice point indicating a cue-out splice event in a splice information table.

The PTS value identified in step S20 thereby indicates the PTS value of the first picture of the video insert. Accordingly, the PTS value identified in step S20 allows identification of the start of the video insert.

The PTS values can also be used to determine whether a current picture belongs to the video program or the video insert by comparing the PTS value of the current picture with the PTS value identified in step S20 and corresponding to the PTS value of the splice point indicating a cue-out splice event. Thus, PTS values enable determining whether the brightness of the current picture should be used to determine or update the program brightness metric or the insert brightness metric.

In such an embodiment, step S1 of FIG. 1 comprises updating the program brightness metric based on a picture having a PTS value lower than the PTS value of a splice point indicating a cue-out splice event. Step S2 comprises, in this embodiment, updating the insert brightness metric based on a picture of having a PTS value equal to or higher than the PTS value of the splice point.

This means that if the PTS value of a current picture is lower than the PTS value identified in step S20 then the picture is regarded as being a picture of the video program. Accordingly, the brightness of the current picture should then be used to update the program brightness metric. Correspondingly, if the PTS value of the current picture is equal to or higher than the PTS value identified in step S20 then the picture is regarded as being, or at least potentially being, a picture of the video insert. Accordingly, the brightness of the current picture should then be used to update the insert brightness metric.

As mentioned in the foregoing, the splice information table contains information of not only splice points indicating a cue-out splice event but preferably also information of splice points indicating a cue-in splice event. In such a case, the PTS value indicating the end of the video insert or the PTS value indicating the starting point of resuming the video program could also be used.

In such a case, pictures of the video insert are indicated based of the PTS value of the splice point indicating a cue-out splice event and of the PTS value of the following splice point indicating a cue-in splice event. The pictures having PTS values within these two PTS values are identified as pictures of the video insert and their brightnesses should therefore be used to update the insert brightness metric.

Correspondingly, picture having PTS values below the PTS value of the splice point indicating a cue-out splice event or having PTS values equal to or above the PTS value of the following splice point indicating a cue-in splice event are identified as pictures of the video program.

In an embodiment, the video control method continues from step S20 in FIG. 3 to step S21. This step S21 comprises identifying a PTS value of a splice point indicating a cue-in splice event in the splice information table. Step S22 comprises resetting the program brightness metric based on the PTS value of the splice point indicating the cue-in splice event. Step S23 correspondingly comprises resetting the insert brightness metric based on the PTS value of the splice point indicating the cue-out splice event. The method then continues to step S1 in FIG. 1.

In an embodiment when the method continues from step S23 in FIG. 3 to step S1 in FIG. 1, step S1 preferably comprises updating the program brightness metric based on a picture having a PTS value equal to or higher than the PTS value of the splice point indicating the cue-in splice event.

In this embodiment, the brightness metrics are reset, preferably reset to zero or reset to some predefined starting value, at splice points. Thus, the program brightness metric is reset at the point of resuming the video, i.e., at the splice point indicating a cue-in splice event. Correspondingly, the insert brightness metric is reset at the start of the video insert, i.e., at the splice point indicating a cue-out splice event.

Also other techniques can be used to identify the start of the video insert and the end of the video insert, i.e., the resumption of the video program. For instance, the bitstream comprising the encoded pictures of the video program and the video insert could contain, or otherwise be associated with, such as in the form of side information, metadata marking portions of the bitstream as corresponding to the video insert or corresponding to the video program. For instance, a Boolean flag assuming either the value of 0 or 1 could be used to identify different portions of the bitstream as corresponding to the video insert or the video program.

The portions of the bitstream marked by such a metadata could be a picture, a group of picture or a sequence of pictures. In the former case, the metadata, such as Boolean flag, could be included in a header portion of the encoded picture data of the picture or group of pictures. In the case of a sequence of pictures, the metadata could be present in a picture parameter set (PPS), a sequence parameter set (SPS) or a video parameter set (VPS) assigned to the sequence of pictures.

In an embodiment, only the last picture prior to the splice point and/or the first picture following the splice point is marked with the metadata, such as Boolean flag. In this embodiment, the following pictures are then presumed to be of a given type, i.e., video program pictures or video insert pictures, until the next metadata is provided.

The program brightness metric and the insert brightness metric determined as described in the foregoing are then used in step S3 of FIG. 1 as a basis to decide whether to adjust the brightness of at least an initial portion of decoded pictures of the video insert or to keep the brightness unadjusted.

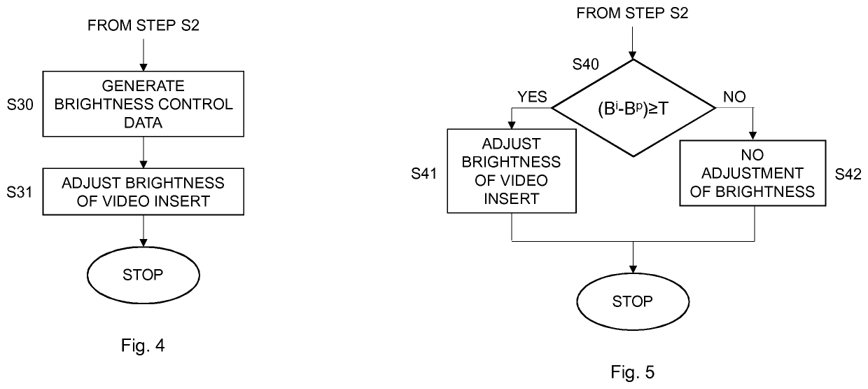

In an embodiment, step S3 is performed as further shown in FIG. 4. The video insert control method continues from step S2 in FIG. 1. A next step S30 comprises generating brightness control data based on the program brightness metric and the insert brightness metric. The following step S31 then comprises adjusting brightness of at least the initial portion of decoded pictures of the video insert based on the brightness control data.

Thus, brightness control data or instructions are generated based on the brightness metrics and this brightness control data or instructions are then used in order to adjust the brightness of at least the initial portion of decoded pictures of the video insert.

In a particular embodiment, the generation of the brightness control data in step S30 is made based on a comparison of the two brightness metrics. For instance, a difference can be calculated between the insert brightness metric and the program brightness metric and this difference is used in step S30 to generate the brightness control data. In another embodiment, a quotient is calculated between the insert brightness metric and the program brightness metric and this quotient is then used in step S30 to generate the brightness control data.

In a particular embodiment, the brightness control data contains information or data indicating the amount that the brightness is to be adjusted in step S31. Then this amount of brightness adjustment is preferably determined based on the above mentioned difference or quotient between the insert brightness metric and the program brightness metric. For instance, the brightness control data could be generated based on and include information defining how much the difference or the quotient differs from a threshold value, e.g.,

$$( ( {B}_{est}^{i} ( t ) - {B}_{est}^{p} ( t ) ) - T ) or \frac{{B}_{est}^{i}}{{B}_{est}^{p}} - T ,$$

wherein T represents the above mentioned threshold value. Hence, in particular embodiments the brightness control data is generated to comprise or represent one of the above exemplified differences between the brightness metric difference and the threshold value or between the brightness metric quotient and the threshold value.

Instead of determining the brightness control data based on and include information of how much the difference differs from the threshold as mentioned above, the brightness control data could be determined based on and include information of the difference between the absolute difference between the brightness metrics and the threshold value, i.e., (|Bₑₛₜⁱ(t)−Bₑₛₜ^{p}(t)|−T), or the difference between the squared difference between the brightness metrics and the threshold value, i.e., ((Bₑₛₜⁱ(t)−Bₑₛₜ^{p}(t))²−T).

The brightness adjustment in step S31 could involve adjusting the brightness of only an initial portion of decoded pictures of the video insert. In such an embodiment, no brightness adjustment is made in step S31 on the following and remaining portion of decoded pictures of the video insert. The initial portion could be a predefined initial portion of the video insert. This can be achieved according to various embodiments. In an embodiment, the initial portion of the video insert corresponds to a predefined number of seconds of the video insert. For instance, the initial portion could correspond to the first or initial t s of video of the video insert for some defined value of t, such as 5 to 10 s. In another embodiment, the initial portion of the video insert corresponds to a predefined number of decoded pictures of the video insert. For instance, the initial portion could correspond to the first or initial N decoded pictures that are output for display for the video insert for some defined value of N. The value of N could be fixed or predefined. Alternatively, the value of N could depend on the picture rate of the video insert. In this latter case, the value of N is preferably larger for a video insert having a high picture rate as compared to a video insert having a comparatively lower picture rate. In a further embodiment, the initial portion of the video insert corresponds to the initial or first percentage of the video insert. This percentage could then apply to the duration, i.e., length, of the video insert, or apply to the number of pictures in the video insert. In a particular embodiment relating to the applying the brightness adjustment to a percentage of the video insert, the duration of the video insert or the number of pictures in the video insert is known or determined in advance. For instance, SCTE-35 allows including such information in the cue-out splice point. This is generally denoted break duration in the art. It is also possible to calculate the percentage even if the duration of the video insert is not known in advance. Such an approach, though, requires buffering of quite a lot of decoded pictures of the video insert, which is generally not preferred.

In another embodiment, the adjustment performed in step S31 is applied to all decoded pictures of the video insert. Hence, in this embodiment step S31 comprises adjusting the brightness of all decoded pictures of the video insert based on the brightness control data.

Regardless of adjusting the brightness of only the initial portion of the video insert or of all decoded pictures of the video insert, the same brightness adjustment is, in an embodiment, applied to the initial portion of decoded pictures of the video insert or is applied to all decoded pictures of the video insert.

In another embodiment, different brightness adjustments are applied to different decoded pictures within the initial portion of the video insert or among the whole video insert. In a particular embodiment, a brightness adjustment applied to a given decoded picture of the video insert that precedes another decoded picture of the video insert in output order, i.e., the order at which decoded pictures are output, such as output for display, is preferably larger than the brightness adjustment applied to the other decoded that follows the given decoded picture according to the output order. This means that the further video insert progresses the less the brightness adjustment and the largest brightness adjustment will be at the start of the video insert.

An embodiment of achieving such a differential brightness adjustment, i.e., not necessarily adjusting the brightness to the same extent or level for all the decoded pictures in the initial portion of the video insert or in the complete video insert, is to perform a gradual decline or decrease in brightness adjustment. In such an embodiment, step S31 comprises adjusting, with a gradually declining brightness adjustment, the brightness of at least the initial portion of decoded pictures of the video insert based on the brightness control data.

Such a gradual decline in brightness adjustment could, for instance, be achieved by applying the brightness adjustment as defined by the brightness control data to the first M decoded pictures or to the first m seconds of video of the video insert and then applying, for instance 75% of the brightness adjustment as defined by the brightness control data to the following M decoded pictures or to the following m seconds of video of the video insert and then continuing with application of a brightness adjustment corresponding to 50% and a 25% of the brightness adjustment defined by the brightness control data for the next sets of M decoded pictures or to the next sets of m seconds of video of the video insert. In this illustrative example, the brightness adjustment is gradually stepped down from an initial brightness adjustment, i.e., 100%, as defined by the brightness control data to 75%, 50% and 25%. This means that after 4×M decoded pictures or after 4×m seconds of video data no more brightness adjustment is applied to the following decoded pictured of the video insert. The parameter M is a positive integer equal to or larger than one and m is a defined time duration.

The embodiments are not limited to gradually declining the brightness adjustment in four steps and with the reduction examples as mentioned in the foregoing. Thus, fewer or more steps could be used in the gradual decline of brightness adjustment and then possibly with other reductions in brightness adjustments than what was exemplified above.

The gradual decline in the adjustment in brightness of the video insert achieves a smooth transition from the video program to the video insert at the splice point by adjusting the brightness of at least the initial portion of decoded pictures of the video insert so that any difference in brightness between the portion of the video program prior to the splice point and the initial portion of the video insert is reduced. The gradual decline additionally, in a smooth manner, restores the original brightness of the video insert from the brightness level achieved by the brightness adjustment to the original brightness level as defined by the pixel data of the video insert without any modification of brightness.

This gradual decline in brightness adjustment thereby also achieves a visually more pleasant experience for the viewer as compared to restoring the brightness of the video insert in a single step from the last decoded picture of the initial portion of decoded pictures in the video insert to the first decoded picture of the video insert following this initial portion.

If the brightness adjustment, however, is applied to all decoded pictures of the video insert then of course no restoring of the brightness of video insert is needed and there will not be any visually unpleasant jumps in brightness level within the video insert.

FIG. 5 is a flow chart illustrating an embodiment of the decoding step S3 in FIG. 1. The video insert control method continues from step S2 in FIG. 1. A next step S40 comprises comparing a difference between the program brightness metric and the insert brightness metric with a threshold value. If the difference is equal to or exceeds the threshold value the video insert control method continues to step S41 otherwise the video insert control method continues to step S42. Step S41 comprises deciding to adjust brightness of at least the initial portion of decoded pictures of the video insert. Step S42 correspondingly comprises deciding not to adjust brightness of the at least an initial portion of decoded pictures of the video insert.

In this embodiment, the difference between the program brightness metric and the insert brightness metric, represented by (Bⁱ−B^{p}) in FIG. 5, is compared to the previously mentioned threshold value T to decide whether to adjust brightness of at least the initial portion of decoded pictures of the video insert, i.e., if (Bⁱ−B^{p})≥T, or not to adjust brightness of the at least initial portion, i.e., if (Bᵢ−B^{p})<T.

The difference between the program brightness metric and the insert brightness metric could be a difference, i.e., (Bⁱ−B^{p}), an absolute difference, i.e., |Bⁱ−B^{p}| or a squared difference, i.e., (Bⁱ−B^{p})², as illustrative but non-limiting examples.

In another embodiment, step S40 comprises comparing a quotient between program brightness metric and the insert brightness metric, i.e.,

$$\frac{{B}^{i}}{{B}^{p}} .$$

If the quotient is equal to or larger than the threshold value the method continues to step S41 otherwise the method continues to step S42. In a further embodiment, step S40 comprises comparing a quotient between the insert brightness metric and the program brightness metric, i.e.,

$$\frac{{B}^{p}}{{B}^{i}} ,$$

with the threshold value.

In a particular embodiment, step S41 comprises adjusting brightness of at least the initial portion of decoded pictures of the video insert based on a value derived from the program brightness metric, the insert brightness metric and the threshold value.

For instance, step S41 could comprise adjusting the brightness of at least the initial portion of decoded pictures of the video insert based on a value equal to a difference between the difference between the program brightness metric and the insert brightness metric and the threshold value. In this example embodiment, the value based on which the brightness is adjusted in step S41 is calculated as (Bⁱ−B^{p})−T, |Bⁱ−B^{p}|−T or (Bⁱ−B^{p})²−T. This then means that the brightness of the pixels of a decoded picture in the initial portion of the video insert is adjusted with this value or with a value derived based on this value. Thus, in a general approach the brightness adjustment is function of (Bⁱ−B^{p})−T, |Bⁱ−B^{p}|−T or (Bⁱ−B^{p})²−T, i.e., ƒ((Bⁱ−B^{p})−T), ƒ(|Bⁱ−B^{p}|−T) or ƒ ((Bⁱ−B^{p})²−T) for some function ƒ( ). The function may simply output the value or could output a percentage of the value in the case of a stepwise or gradual decline in brightness adjustment.

Assume, in an example, that the brightness representing parameter of the pixels in a decoded picture is the luma parameter Y′. In such a case, the luma value Y′ of each pixel in a decoded picture is then adjusted with this value, e.g., Y′−(|Bⁱ−B^{p}|−T) or Y′−ƒ(|Bⁱ−B^{p}|−T). The brightness adjusted luma value may then optionally be clipped within an allowed range of luma values. Thus, if the brightness adjustment results in a luma value that is smaller than a minimum allowed luma value then the brightness adjusted luma value is replaced by the minimum allowed luma value. This is typically performed by a clipping function Clip3(a, b, x)=max(a, min(b, x)), which outputs a if x≤a, outputs b if x≥b and otherwise outputs x. For instance, a luma value Y′ represented by 8 bits could have an allowed range of [16, 235], wherein 16 indicates black and 235 indicates white. In this case, a=16 and b=235 in the clipping function.

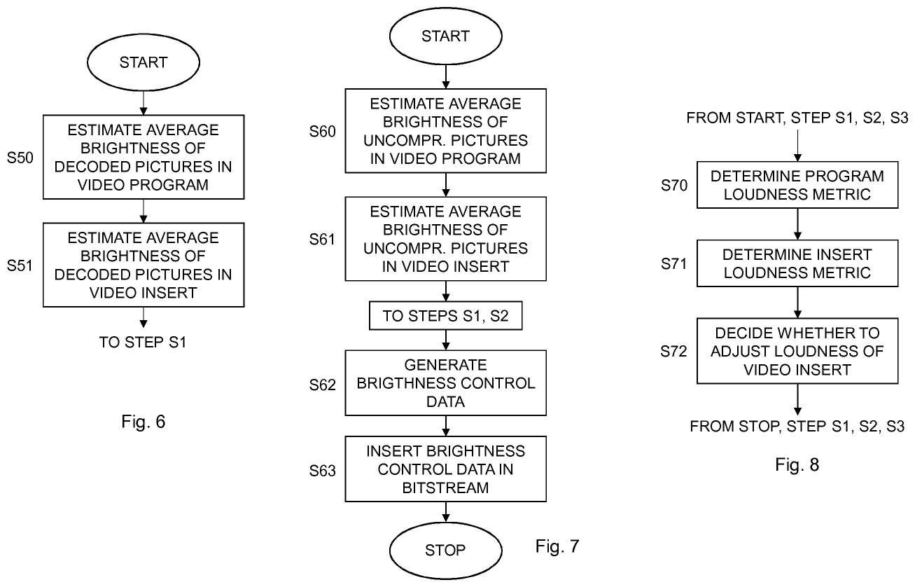

FIG. 6 is a flow chart illustrating additional, optional steps of the video insert control method shown in FIG. 1. Step S50 of FIG. 6 comprises estimating respective average brightness of decoded pictures of the video program. Step S51 correspondingly comprises estimating respective average brightness of decoded pictures of the video insert. The video insert control method then continues to step S1 in FIG. 1. In this embodiment, step S1 comprises determining the program brightness metric based on the respective average brightness of decoded pictures of the video program. Step S2 comprises determining the insert brightness metric based on the respective average brightness of decoded pictures of the video insert.

Thus, in this embodiment, an average brightness is estimated for decoded pictures of the video program and the video insert. This means that a bitstream representing encoded pictures of the video program and of the video insert is input into a video decoder in order to get decoded pictures. The average brightness is then estimated for the decoded picture in this embodiment. This can be achieved, for instance, by summing all luma values Y′ of the pixels in the decoded picture prior to conversion from the Y′CbCr color space into the RGB color space. The summed luma value is then divided by the number of pixels in the picture. If another brightness representing parameter is used instead of luma value, such as average or weighted average of R, G, B values, luminance value Y or intensity value L* then the estimation is performed after conversion of the Y′CbCr value into the appropriate color space, such as Y′CbCr→R′G′B′→RGB and then optionally further into RGB-XYZ and optionally XYZ→L*a*b*.

In the case of luminance Y as brightness representing parameter, then only the luminance value Y needs to be calculated for the pixels, thereby omitting the calculation of the chrominance values X, Z. Correspondingly, only the intensity value L* needs to be calculated, which in turn only depends on Y and not X, Z, thereby omitting the calculation of the color values a*, b*.

In more detail,

$$L *= 116 f \frac{Y}{{Y}_{n}} - 16 ,$$

wherein Y denotes the luminance value and Yₙ is the luminance value of the CIE XYZ tristimulus values of the reference white point. Under Illuminant D65 with normalization

$${Y}_{n} = 100 , \\ f = \{ \begin{matrix}\sqrt[3]{t} & if t > {δ}^{3} \\ \frac{t}{3 {δ}^{2}} + \frac{4}{29} & otherwise\end{matrix} and δ = \frac{6}{29}$$

Correspondingly, the luminance value Y can be calculated as a linear combination of R, G, B values, i.e., Y=w_{R}R+w_{G} G+w_{B}B, wherein the values of the weights w_{R}, w_{G}, w_{B} depend on whether the R, G, B values originate from BT.2020, BT.709 or some other color space, i.e., Y=0.262700R+0.677998G+0.059302B for BT.2020 and Y=0.212639R+0.715169G+0.072192B for BT.709. The R, G, B values are in turn obtained from Y′CbCr by first calculating non-linear red, green and blue values R′, G′, B′:

R′=Y′+a₁₂Cb+a₁₂Cr

G′=Y′+a₂₂Cb+a₂₃Cr

B′=Y′+a₃₂Cb+a₃₃Cr

In the equation above, the constants a₁₂=0 and a₃₃=0, whereas the other constant values depend on the color space. Thus, for color space BT.709 we have a₁₃=1.57480, a₂₂=−0.18733, a₂₃=−0.46813, a₃₂=1.85563 and for BT.2020 we have a₁₃=1.47460, a₂₂=−0.16455, a₂₃=−0.57135, a₃₂=1.88140. The R, G, B values are obtained by applying a transfer function, such as the electro-optical transfer function (EOTF) to the non-linear R′, G′, B′ values, i.e.

$$R = EOTF ( {R}^{′} )$$

$$G = EOTF ( {G}^{′} )$$

$$B = EOTF ( {B}^{′} ) .$$

In steps S50 and S51, the average brightness of decoded pictures is estimated. In alternative embodiments, these two steps S50 and S51 instead comprise estimating a respective median brightness, a respective maximum brightness or a respective minimum brightness of decoded pictures of the video program, in step S50, or of the video insert, in step S51.

The video insert control method as described above and illustrated in FIG. 6 is typically performed in a user device comprising a video decoder, such as in an STB or video player. FIG. 7 illustrates additional method steps that are typically performed in a video service provider or server comprising a video encoder.

Step S60 of FIG. 7 comprises estimating respective average brightness of uncompressed pictures of the video program. Step S61 correspondingly comprises estimating respective average brightness of uncompressed pictures of the video insert. The video insert control method then continues to steps S1 and S2 in FIG. 1. In this embodiment, step S1 comprises determining the program brightness metric based on the respective average brightness of uncompressed pictures of the video program. Step S2 correspondingly comprises determining the insert brightness metric based on the respective average brightness of uncompressed pictures of the video insert. Step S3 is, in this embodiment, performed as shown in steps S62 and S63 of FIG. 7. Step S62 comprises generating brightness control data based on the program brightness metric and the insert brightness metric. This brightness control data is then inserted in step S63 in a bitstream comprising encoded pictures of the video program and encoded pictures of the video insert.

Steps S60 and S61 thereby differ from the steps S50 and S51 in FIG. 6 by estimating the average brightness of uncompressed pictures, whereas steps S50 and S51 instead performed the estimations of the average brightness of decoded pictures.

In an embodiment, the uncompressed pictures are so-called raw pictures as output from a video camera or a video generating equipment. This means that the pictures are in uncompressed and uncoded format, i.e., pre-compressed or pre-encoded. The average brightness is then estimated on the uncompressed or raw pixel data, such as in the RGB color space or following conversion from the RGB space into the Y′CbCr color or another color space as described herein. The pictures are then input into a video encoder in order to generate the bitstream into which the brightness control data is inserted in step S63.

The uncompressed pictures used in steps S60 and S61 to estimate average brightness do, however, not need to be raw pictures. For instance, the uncompressed pictures could be reconstructed pictures obtained during a so-called transcoding process. Such transcoding involves decoding a bitstream of encoded pictures to obtain reconstructed or decoded pictures. These reconstructed or decoded pictures are then typically further processed to, for instance, change the bitrate, typically denoted transrating, or change the image scaling, typically denoted transsizing, before the processed pictures are encoded.

In such an application in connection with transcoding, the estimation of average brightness in step S60 and S61 could be performed following decoding but prior to the processing and the encoding or following the decoding and the processing but prior to the encoding.

The brightness control data generated in step S62 based on the program brightness metric and the insert brightness metric determined in steps S1 and S2 and based on the estimations obtained in steps S60 and S61 could be similar type of data or information as generated in step S30 of FIG. 4. Thus, the brightness control data could be generated based on, or include information of, a difference between the insert brightness metric and the program brightness metric or a quotient between the insert brightness metric and the program brightness metric. Alternatively, or in addition, the brightness control data generated in step S62 could comprise information or data indicating the amount or level that the brightness is to be adjusted.

The brightness control data generated in step S62 is then inserted into the bitstream in step S63. For instance, the brightness control data could be included into header portion of pictures of, preferably, the video insert and optionally into pictures of the video program. For instance, brightness control data indicating the amount that the brightness is to be adjusted by could be included in the header portion of pictures of the video insert, the brightness of which is to be adjusted based on the brightness control data.

Alternatively, or in addition, the brightness control data could be included into an information field or set applicable to multiple pictures, such as multiple pictures of the video insert. Non-limiting, but illustrative, examples of such information fields or sets include a PPS, an SPS, a VPS. In such a case, the brightness control data is present in at least one PPS, SPS and/or VPS of the bitstream. The pictures of the video insert having a brightness that should be adjusted based on the brightness control data then preferably comprises a respective identifier to the PPS, SPS and/or VPS comprising the brightness control data.

It is possible to combine signaling brightness control data both in header portion and signaling brightness control data in at least one PPS, at least one SPS and/or at least one VPS. For instance, the at least one PPS, SPS and/or VPS could then comprise brightness control data indicating a general brightness adjustment. Then individual brightness adjustments could be included as brightness control data in the header portion. In such a case, if a picture of the video insert comprises brightness control data in its header portion then this brightness control data could be used for the picture even if the picture also refers to a PPS, SPS or VPS comprising brightness control data. Alternatively, the total adjustment of the brightness of a picture of the video insert could be a sum or other combination of the general brightness adjustment in the PPS, SPS or VPS and the individual brightness adjustments as defined in the header portion.

The brightness control data generated in step S62 could alternatively, or in addition, be included in supplemental enhancement information (SEI) associated with the bitstream.

In steps S60 and S61, the average brightness of uncompressed pictures is estimated. In alternative embodiments, these two steps S60 and S61 instead comprise estimating a respective median brightness, a respective maximum brightness or a respective minimum brightness of uncompressed pictures of the video program, in step S60, or of the video insert, in step S61.

The decision of adjusting the brightness of at least the initial portion of decoded pictures of the video insert based on the program brightness metric and the insert brightness metric could be made at each splice point from the video program to a video insert, i.e., at each cue-out splice point. Alternatively, the decision of adjusting the brightness is made at only at least one or a subset of the cue-out splice points.

Correspondingly, any brightness adjustment of at least the initial portion of decoded pictures in a video insert could be performed regardless of whether the transition at the splice point is from a “dark” video program to a “bright” video insert or from a “bright” video program to a “dark” video insert. This is achieved by comparing the absolute difference or squared difference between the brightness metrics with the threshold value.

In an alternative embodiment, any brightness adjustment of at least the initial portion of decoded pictures in a video insert is only made in connection with a cue-out splice point from a “dark” video program to a “bright” video insert. This can be achieved by comparing the difference between the brightness metrics with the threshold value, or by comparing the brightness metrics with each other prior to comparing their, for instance, absolute or squared difference with the threshold value. For instance, assume that the brightness representing parameter is luma value Y′. In such a case, a low luma value Y′ indicates a dark pixel, whereas a high luma value Y′ indicates a bright pixel. This means that the difference between the brightness metrics (Bⁱ−B^{p})>0 for a cue-out splice point from a “dark” video program to a “bright” video insert and the difference is correspondingly negative for a cue-out splice point from a “bright” video program to a “dark” video insert.

Accordingly, in a particular embodiment the method comprises comparing the program brightness metric with the insert brightness metric to identify or determine whether the cue-out splice point is from “dark” video program to a “bright” video insert, e.g., whether Bⁱ>B^{p}. In such a case, the decision of whether to adjust the brightness of at least the initial portion of decoded pictures of the video insert is only made if the cue-out splice point is identified as a cue-out splice point from a “dark” video program to a “bright” video insert.

“Dark” and “bright” as used herein merely relates to the relative difference in brightness representing parameter of the video program and the video insert. For instance, a video program is regarded as “dark” and a video insert is regarded as “bright” if the luma-based brightness metric of the video program is lower than the luma-based brightness metric of the video insert.

The embodiments as described herein decides whether to adjust brightness in connection with cue-out splice points. It is of course possible, but generally less preferred, to perform a similar decision of whether to adjust brightness in connection with cue-in splice points. In such a case, the method comprises a decision step comprising deciding whether to adjust brightness of at least a final portion of decoded pictures of the video insert based on the program brightness metric and the insert brightness metric.

In this embodiment, the program brightness metric is preferably determined to represent the current brightness of a portion of the video program immediately prior to the video insert, i.e., prior to the cue-out splice point. It is then assumed that the portion of the video program immediately following the video insert, i.e., following the cue-in splice point, has substantially the same brightness level as the portion of the video program immediately prior to the video insert. Thus, the previously described program brightness metric is still valid for the portion of the video program immediately following the video insert.

In an alternative embodiment, the program brightness metric is determined for the portion of the video program following the video insert and is used together with the insert brightness metric representing the brightness of the final portion of the video insert to decide whether to adjust brightness of at least the final portion of decoded pictures of the video insert.

Although less preferred, the method may optionally comprise deciding whether to adjust brightness of an initial portion of decoded pictures of the video program following the cue-in splice point based on the program brightness metric and the insert brightness metric to achieve a smoother transition back from the video insert to the video program. However, it is generally preferred to leave the brightness level of the video program unadjusted and instead perform any brightness adjustments on decoded pictures of the video insert.

The above described embodiments of adjusting the brightness of at least an initial portion of decoded pictures of the video insert could be combined with adjustment of loudness of at least an initial portion of decoded audio frames of the video insert.

While some effort has been spent on making sure programs and adverts have a somewhat consistent loudness level, most notably with the Commercial Advertisement Loudness Mitigation (CALM) act, those solutions are typically based on the average level of each video program or advert. The short-term variability in loudness is still not taken into account, making it still possible for there to be disruptive transitions, such as a quiet movie scene followed by a loud slogan at the start of a commercial break.

FIG. 8 illustrates a flow chart with such optional steps adjusting the loudness of the video insert. The video insert control method starts in step S70 or continues from any of steps S1, S2 and S3 in FIG. 1. The following step S70 comprises determining a program loudness metric of the video program. The loudness brightness metric represents a current loudness of the video program. Step S71 correspondingly comprises determining an insert loudness metric of the video insert. The insert loudness metric represents a current loudness of the video insert. The following step S72 comprises deciding whether to adjust loudness of at least an initial portion of decoded audio frames of the video insert based on the program loudness metric and the insert loudness metric. The video insert control method then ends or continues to any of the steps S1, S2 and S2 in FIG. 1.

The determination of the loudness metrics in steps S70 and S71 can be determined in a similar way as for the brightness mentioned in the foregoing but with the difference that loudness is determined based on audio frames of the video program and the video insert, respectively. The audio frames could be decoded audio frames, “raw” audio frames, or decoded or reconstructed audio frames in connection with transcoding.

The program and insert loudness metrics could be determined as rolling loudness metrics representing the current loudness of the video program and the video insert, respectively.

The initial portion of decoded audio frames mentioned above in connection with step S72 could have a duration similar to or even equal to the duration of the initial portion of decoded pictures in the video insert. Alternatively, the duration of the decoded audio frames could be longer or shorter than the duration of the initial portion of decoded pictures of the video insert.

The optional loudness adjustment as described above could be made at each cue-out splice point. In another embodiment, any loudness adjustment of at least the initial portion of decoded audio frames of the video insert is only made in connection with a transition from a “silent” video program to a “loud” video insert. Hence, any loudness adjustments are only performed in order to reduce the loudness of the video insert and not for increasing the loudness of the video insert in the case the video program has a higher loudness as compared to the initial portion of the video insert.

Any decisions of loudness adjustments may optionally also be made in connection with cue-in splice points in similarity to what has been described above for brightness adjustments in connection with cue-in splice points.

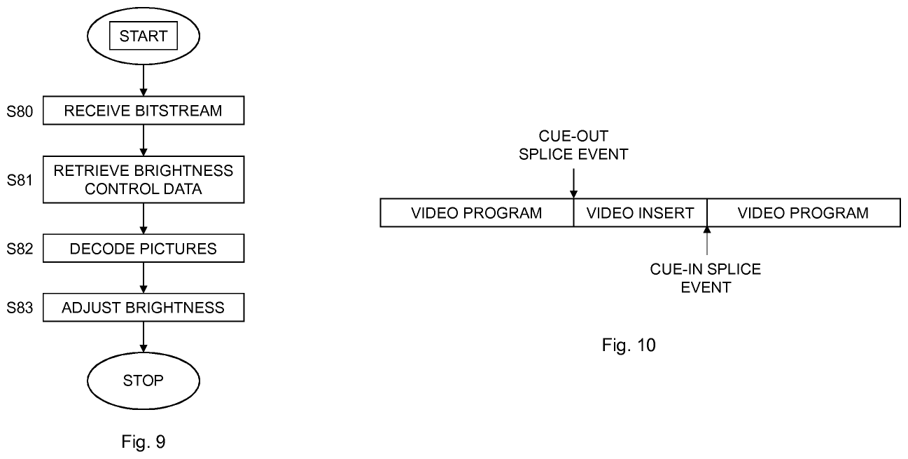

FIG. 9 is a flow chart illustrating a brightness control method according to an embodiment. The video insert control method comprises receiving, in step S80, a bitstream comprising encoded pictures of a video program and encoded pictures of a video insert. A next step S81 comprises retrieving, from the bitstream and for at least an initial portion of encoded pictures of the video insert, brightness control data representing a brightness adjustment. Encoded pictures of the video program and encoded pictures of the video insert are decoded in step S82. Then a brightness of at least an initial portion of decoded pictures of the video insert is adjusted in step S83 based on the brightness control data.

This embodiment is preferably performed in an STB or other user device that receives the bitstream of encoded pictures of the video program and the video insert, such as from a video server, service provider or other type of headend. The bitstream then comprises brightness control data generated as previously described, such as in connection with step S62 in FIG. 7. This brightness control data is then used to adjust brightness of at least the initial portion of decoded pictures of the video insert in step S83 and preferably as described in the foregoing.

The brightness control data retrieved from the bitstream in step S81 and used step S83 is preferably generated based on a program brightness metric of the video program and an insert brightness metric of the video insert. The program brightness metric represents a current brightness of the video program and the insert brightness metric represents a current brightness of the video insert spliced into the video program during the ongoing video session.

The identification of the initial portion of decoded pictures of the video insert is preferably as previously described herein, such as in connection with FIGS. 2 and 3.

### Implementation Example

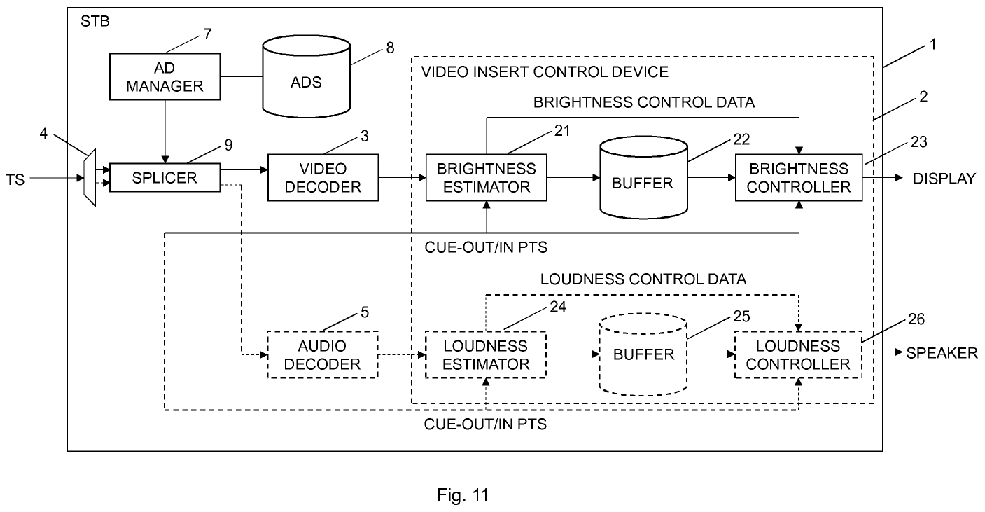

When an MPEG-2 Transport Stream (TS) is being received by an STB 1 supporting DPI, its splicer 9 constantly monitors incoming packets for the presence of SCTE-35 splice information tables on the appropriate Packet Identifier (PID) stream, see FIG. 11. Upon reception of a splice point, the splicer 9 starts inserting an advert (ad) selected by an ad manager 7 and retrieved from an ad server or storage (ADS) 8. At this point, the PTS value associated with the first picture and optionally the first audio frame of the ad to be played out by the STB 1 are known by the splicer 9, which communicates them to a brightness estimator 21 and optionally to a loudness estimator 24, as well as a brightness controller 23 and optionally a loudness controller 26 located further downstream the data flow.

The TS input to the STB 1 is de-multiplex by an optional de-multiplexer 4, typically implemented upstream of the splicer 9 but could alternatively be implemented between the splicer 9 and the video decoder 3 and the optional audio decoder 5. The de-multiplexer 4 is configured to de-multiplex the TS into video and audio Elementary Streams (ES), which are subsequently processed by the relevant decoders represented by the video decoder 3 and an optional audio decoder 5 in FIG. 11.

Once the pictures and optional audio frames have been decoded and rearranged into presentation order, they are fed into a brightness estimator 21 and an optional loudness estimator 24, respectively. Both include an appropriate algorithm capable of producing an estimate of the short- or medium-term brightness metrics and optional loudness metrics in question.

Each picture or optional audio frame being processed by the brightness estimator 21 or optional loudness estimator 24 is tested for its PTS value against that received from the splicer 9, such that the algorithm only updates one of two rolling brightness or loudness metrics, depending on whether the picture or optional audio frame in question belongs to the original video program, i.e., having a PTS value lower than the splice point PTS, with wrapping taken into account, or an ad, i.e., having a PTS value larger than that of the splice point.

Those brightness and optional loudness metrics would have been previously initialized, such as in the following way. The program brightness metric and optionally the program loudness metric will have been reset at system startup as well as any cue-in splice point. Correspondingly, the insert brightness metric and optionally the insert loudness metric will have been reset at system startup as well as any cue-out splice point. Note that it may be desirable to configure the algorithms in slightly different way for the program brightness/loudness and insert brightness/loudness metrics estimation. For example, it might be appropriate to use a method that accumulates data over a longer period of time, i.e., longer ‘forgetting factor’, for the estimation of the program brightness/loudness metrics than for the insert brightness/loudness metrics, so that the feature provides a good reactivity at the onset of the first ad of a commercial break, where a change in brightness or loudness is the most disruptive to the user experience.

Since the brightness metrics and the optional loudness metrics are estimated over a period of time, decoded pictures, also referred to as decoded video frames, and optionally decoded audio frames then require buffering before any significant divergence detected between the video program and the beginning of the first ad can be acted upon. Therefore, once a decoded picture and optionally a decoded audio frame has been used to update the brightness or loudness metric estimate, it gets pushed into a First-In-First-Out (FIFO) buffer 22, 25, and the oldest decoded picture or audio frame gets pushed or popped out of the buffer 22, 25 instead. This pushed out decoded picture or decoded audio frame is then passed on to the brightness controller 23 or the optional loudness controller 26, which are responsible for adjusting the brightness of the decoded picture or the loudness of the decoded audio frame, if required.

When a decoded picture is processed by the brightness controller 23, its PTS value is tested against that received from the splicer 9. If the decoded picture belongs to the video program, it is passed through unchanged, and forwarded for display. If however it is the first decoded picture following a splice point, and the program and insert brightness metrics received from the brightness estimator 21 are such that their difference, in absolute value, is larger than a given threshold, it means that the last scene of the video program and the start of the first ad exhibit a significant difference in brightness level.

Suitable algorithms for performing brightness estimation and brightness control have been described herein. However, for the sake of example only, one can consider the following simple illustration. The brightness estimator 21 may, for instance, use an exponentially smoothed measure of the average luma value Y′ of a picture in a Y′CbCr color space calculated as Y′ₑₛₜ(t)=αY′(t)+(1−α)Y′ₑₛₜ(t−1) with a smoothing factor calculated as

$$α = 1 - exp ( - ( \frac{1}{r} ) \text{/} τ )$$

and r denotes picture rate and T is a time constant describing the length of the time window over which the estimate is predominantly based upon, for example τ=5 s for the video program and τ=2 s for the ad. The time constant also determines the length of the FIFO buffer 22 to be used between the brightness estimator 21 and the brightness controller 23, such as r×τ decoded pictures are stored in the FIFO buffer 22.

With this example, and assuming the luma estimate, i.e., the program brightness metric, for the last few seconds of the video program before the splice point was found to be 40 on an 8-bit range of [16-235], wherein 16 indicates black and 235 indicates white, and assuming the luma estimate, i.e., the insert brightness metric, for the first few seconds of the ad was found to be 220, the difference between the brightness metrics would be calculated as 220-40=180 on that range. In that case, if the algorithm was designed to act when the brightness metrics differ by more than, for example, 160, it would then have to lower the luma value of all the pixels of the first ad picture by (220−40)−160=20, possibly with values clamped to a minimum of 16 to satisfy the range of validity, before forwarding the picture for display.

In order to provide a smooth overall transition, some level of processing is preferably applied to the subsequent decoded pictures of the ad. Various schemes may be designed to that end. For example, all decoded pictures over the entire commercial break can be modified by the same initial value determined at the start, providing a consistent experience throughout. Alternatively, the pictures of the ad can be modified by a gradually decreasing amount over a certain period of time, so as to bring the brightness level back to its original after that time.

Note that although a similar mechanism could be used for a transition from a bright program scene to a dark advert, it is likely that such a transition is not as disruptive to the user from a sensory perspective as the opposite case. For that reason, an implementation of this invention may act on dark-to-bright transitions only, and leave others unaffected, while another implementation may act on both types of transitions.

When a decoded audio frame is processed by the optional loudness controller 26, its PTS value is tested against that received from the splicer 9. If the decoded audio frame belongs to the video program, it is passed through unchanged, and forwarded for playout at a speaker. If however it is the first decoded audio frame following a splice point, and the program and insert loudness metrics received from the optional loudness estimator 24 are such that their difference, in absolute value, is larger than a given threshold, it means that the last scene of the video program and the start of the first ad exhibit a significant difference in loudness level.

Thus, audio frames popped out of the corresponding FIFO buffer 25 have their PTS value compared against that of the splice point received from the splicer 9, and an algorithm decreases the loudness of the first few, or all of the ad audio frames, if the difference at the transition point is found to exceed a particular threshold. Again, by way of example only, an estimate of loudness can be the exponentially smoothed Root Mean Square (RMS) level of the digital samples of each audio frame, and an associated decision point can be whether the RMS level at the start of the ad break is more than, for example, 12 decibels (dB) above that of the last program scene preceding the ad. If that is the case, a simple negative gain ramp, or a more complex Dynamic Range Compressor (DRC) or limiter algorithm, can take care of attenuating the audio level at the start, or the whole of the ad, so as to provide a smoother loudness transition to the user.

Again, note that although a similar mechanism could be used for a transition from a loud program scene to a quiet advert, it is likely that such a transition is not as disruptive to the user as the opposite case. For that reason, an implementation may act on quiet-to-loud transitions only, and leave others unaffected, while another implementation may act on both types of transitions.

Finally, upon detection of a cue-in splice point by the splicer 9 in the input TS marking the end of the ad avail, this event is communicated to the brightness estimator 21 and optionally to the loudness estimator 24 so that they reset the algorithms estimating the brightness or loudness metrics.

In addition, if the implementation is such that the brightness and loudness of the ads are adjusted over the entire duration of the commercial break rather than only at the start, the PTS value of the first picture following the cue-in splice point is preferably communicated to the brightness controller 23 and optionally to the loudness controller 26 as well, so that they stop modifying the pictures and audio frames, and resume normal pass-through playout instead.

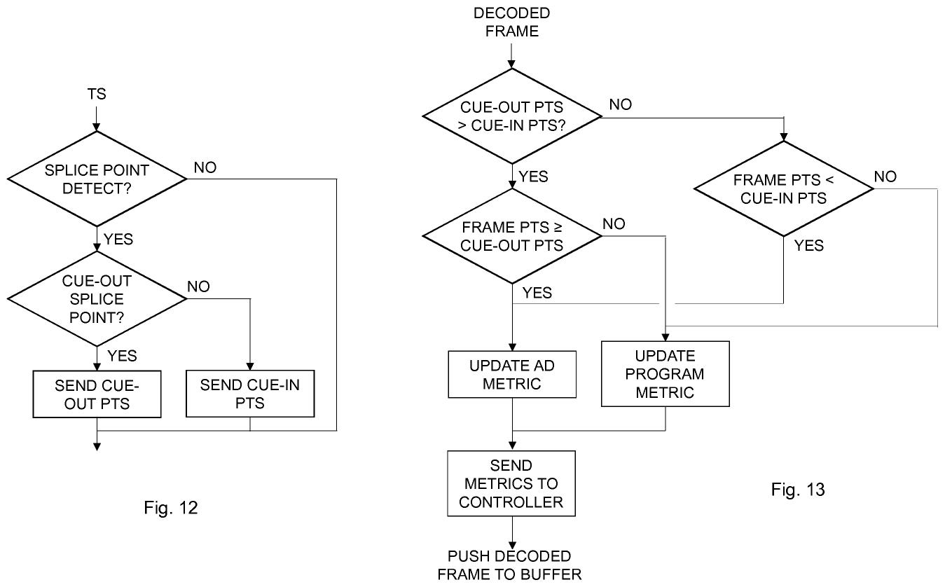

FIG. 12 is a flow chart illustrating operation of the splicer 9 in FIG. 11. The operation involves receiving a TS and checking whether the TS comprises any splice point. If such a splice point is detected the operation continues to check whether the splice point is a cue-out splice point or a cue-in splice point. If the splice point is a cue-out splice point the operations continues by sending the PTS value of the cue-out splice point. However, if the splice point is not a cue-out splice point, i.e., cue-in splice point, the operation comprises sending the PTS value of the cue-in splice point. The PTS values are sent to the brightness estimator 21 and preferably also to the brightness controller 23 for the PTS values of pictures, and to the loudness estimator 24 and preferably also the loudness controller 26 for the PTS values of audio frames.

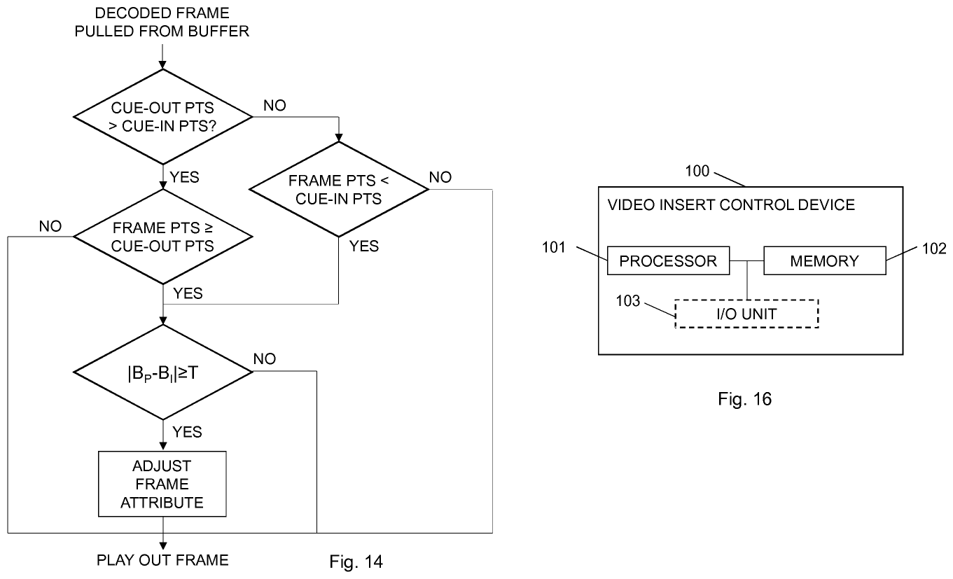

FIG. 13 is a flow chart illustrating operation of the brightness estimator 21 and the optional loudness estimator 24. In the figure and further in FIG. 14, decoded frame is used to denote decoded video frame or picture, with regard to brightness estimator 21 and brightness controller 23, and denote decoded audio frame, with regard to loudness estimator 21 and loudness controller 23.

The operation comprises checking whether the latest cue-out PTS value is larger than the latest cue-in PTS value. If the latest cue-out PTS value is larger than the latest cue-in PTS value then decoded frames having PTS values equal to or larger than the latest cue-out PTS value belong to the ad. Accordingly, once a decoded frame is received its frame PTS value is compared to the latest cue-out PTS value. If the frame PTS value is equal to or larger than the latest cue-out PTS value the current decoded frame belongs to the ad. This means that the insert or ad metric is updated based on the brightness or loudness of the current frame. However, if the frame PTS value is lower than the latest cue-out PTS value the current decoded frame belongs to the video program. Accordingly, the program metric is updated based on the brightness or loudness of the current frame.

However, if the latest cue-out PTS value is equal to or smaller than the latest cue-in PTS value the current decoded frame is determined to belong to the ad if its frame PTS value is lower than the latest cue-in PTS value. In such a case, the ad or insert metric is updated based on the brightness or loudness of the current decoded frame. Correspondingly, if the frame PTS value is equal to or higher than the latest cue-in PTS value the current decoded frame belongs to the video program and its brightness or loudness is used to update the program metric.

The ad or insert brightness metric and the program brightness metric are then sent from the brightness estimator 21 to the brightness controller 23 as brightness control data and optionally the ad or insert loudness metric and the program loudness metric are sent from the loudness estimator 24 to the loudness controller 26.

The decoded frame is also input to the FIFO buffer 22, 25, which pushes the oldest decoded frame 22, out from the buffer 22, 25.

FIG. 14 is a flow chart illustrating operation of the brightness controller 23 and the optional loudness controller 26. First a similar check between the latest cue-out PTS value and the cue-in PTS value as in FIG. 13 is preferably performed in FIG. 14. If the latest cue-out PTS value is larger than the cue-in PTS value and the frame PTS value of current decoded frame pulled from the buffer 22, 25 is larger than the cue-out PTS value then the decoded frame pulled from the buffer belongs to the ad. In such a case, if an absolute difference between the ad metric and the program metric is equal to or larger than a threshold value the frame attribute of the decoded frame pulled from the buffer is adjusted. In this case, frame attribute indicates brightness if the decoded frame is a decoded picture and indicates loudness if the decoded frame is a decoded audio frame. However, if the absolute difference is smaller than the threshold value then no adjustment of the frame attribute is needed.

If the latest cue-out PTS value is equal to or smaller than the latest cue-in PTS value and the frame PTS value of the decoded frame pulled from the buffer 22, 25 is smaller than the latest cue-in PTS value the current decoded frame belongs to the ad. The above-mentioned absolute difference is then compared to the threshold value as previously described. However, if the frame PTS value of the decoded frame is equal to or larger than the latest cue-in PTS value then the current frame belongs to the video program and no adjustment of any frame attribute is performed.

The brightness or loudness controller 23, 26 then outputs the current, optionally frame attribute adjusted, decoded frame for play out.

The above described implementation example is in particular suitable for a localized or personalized adverts insertion at the STB 1, such as described in U.S. Pat. No. 8,997,142. In such a case, the STB 1 comprises a video insert control device 2 comprising the brightness estimator 21, the brightness controller 23 and preferably the FIFO buffer 22. The video insert control device 2 may optionally also comprise the loudness estimator 24, the loudness controller 25 and the FIFO buffer 25.

In order to achieve a localized adverts insertion at the STB 1, the STB 1 comprises an ADS 8 and an ad manager 7. The ADS 8 comprises downloaded and pre-cached adverts, also referred to as ad assets. At a given ad avail slot in the transport stream, i.e., at a cue-out splice point as identified by the splicer 9, the ad manager 7 retrieves an ad from the ADS 8 and inserts it into the transport stream.

The STB 1 may comprise an embedded hardware platform with one or more processors, computer program and memory. The different logical operations, such as splicing, video decoding, brightness estimation, brightness control and optionally audio decoding, loudness estimation and loudness control, may be controlled by a set of individual software processing running in an Operating System (OS), possibly making use of hardware acceleration modules for computationally heavy operations in order to guarantee real-time operation. The OS may implement a set of Application Programming Interfaces (APIs) for inter-process communication (IPC), such as message queues with asynchronous operation.

In an example, upon detection of a splice point in the incoming transport stream, the process responsible for the splicing operation, represented by the splicer 9 in FIG. 11, may make use of the “send message” API that the OS offers in order to communicate the PTS value of the splice point to the processes responsible for brightness estimation, represented by the brightness estimator 21, and brightness control, represented by the brightness controller 23. In turn, depending on the strategy of process prioritization that is implemented by the OS, either or both those other processes may be allowed to run at that point and perform a “read message” API call in order to retrieve that PTS value and store it in their own memory. Alternatively, they could be allowed to only run after the splicing process has finished its current list of tasks, at which point a scheduler of the OS may allow them to run.

The communication mechanism within the video insert control device 2 may be implemented in a variety of ways including, but not limited to, the above mentioned OS-based messages passing between software processes. For instance, a combination of hardware registers and interrupts could alternatively be used.

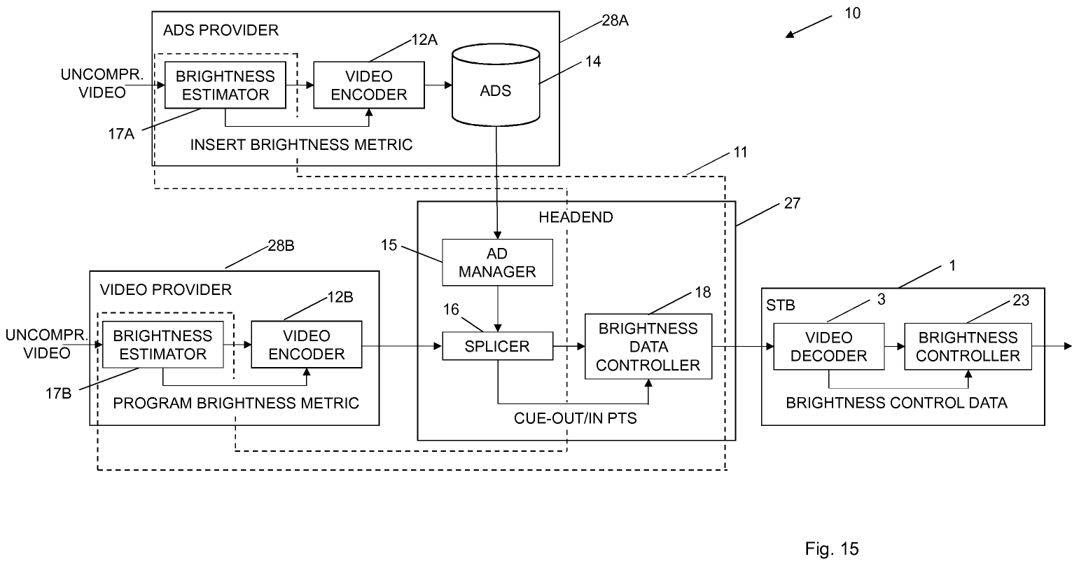

The embodiments are not limited to localized adverts insertion at the STB 1 as shown in FIG. 11. In another embodiment, a centralized ad insertion is performed at a video service provider 10 as shown in FIG. 15. FIG. 15 schematically illustrates the video service provider or system 10 comprising a video provider 28B, an ads provider 28A and a headend 27.

The video provider 28B comprises a brightness estimator 17B that receives, in this implementation example, uncompressed video. This brightness estimator 17B operates in a similar way as the brightness estimator 21 of FIG. 11 but with the difference that it performs the update of the program brightness metric based on brightness of pictures in the uncompressed video as compared to based on brightness of decoded pictures. The brightness estimator 17B also only updates the program brightness metric whereas the brightness estimator 21 of FIG. 11 updates both program and ad brightness metrics. The brightness estimator 17B outputs the program brightness metric that is input to a video encoder 12B. The video encoder 12B also receives the uncompressed video pictures output from the brightness estimator 17B and encodes them into encoded pictures. The video encoder 12B outputs the compressed or encoded video of the video program together with program brightness metric as metadata to the encoded video stream.

The ads provider 28A correspondingly receives uncompressed video of adverts. A brightness estimator 17A of the ads provider 28A operates to update the ad or insert brightness metric based on the brightness of the uncompressed picture. The brightness estimator 17A forwards the updated insert brightness metric to the video encoder 12A, which also receives the uncompressed pictures that are encoded into encoded pictures of the ad. The encoded pictures are then entered in an ADS 14 together with the insert brightness metric as metadata.

A splicer 16 implemented in the headend 27 receives the encoded video program together with the program brightness metric as metadata. At a cue-out splice point in the stream of encoded pictures of the video program an ad manager 15 of the headend 27 selects and retrieves encoded pictures of an ad together with the insert brightness metric as metadata from the ADS 14. The splicer 16 receives the encoded pictured of the ad and inserts them in the stream of encoded pictures of the video program. A brightness data controller 18 receives the brightness metrics and generates brightness control data based on the brightness metrics, such as described in connection with step S62 in FIG. 7. The brightness data controller 18 also inserts the brightness control data in the bitstream comprising the encoded pictures of the video program and the encoded pictures of the ad, such as discussed in connection with step S63 in FIG. 7.

The bitstream is sent from the headend 27 to an STB 1, in which a video decoder 3 decodes the encoded pictures of the bitstream. The video decoder 3 also retrieves and possibly decodes the brightness control data and forwards it to a brightness controller 23. This brightness controller 23 uses the brightness control data to decide whether to adjust brightness of at least the initial portion of decoded pictures of the ad as previously described herein.

In this embodiment, the video insert control device 11 is distributed among the video provider 28B comprising the brightness estimator 17B, the ads provider 28A comprising the brightness estimator 17A, and the headend 27 comprising the brightness data controller 18. In an embodiment, the video insert control device 11 also comprises the brightness controller 23 implemented in the STB 1.

In this implementation example, the estimation of short- or medium-term brightness metrics are performed when the video program and the ad are still in the baseband domain, i.e., prior to encoding, and the brightness metrics are embedded in the bitstream. The headend 27 performs the comparison of the brightness metrics around the cue-out splice point and generates the brightness control data that is included in the bitstream. This brightness control data then preferably defines the level of brightness adjustment that the brightness controller 23 in the STB 1 performs on at least the initial portion of decoded pictures of the ad.

The implementation example shown in FIG. 15 may optionally also comprise a respective loudness estimator and audio encoder in the ads provider 28A and the video provider 28B, respectively. The headend 27 may comprise a loudness data controller and the STB 1 may comprise an audio decoder and a loudness controller in order to achieve an adjustment of not only brightness but also of loudness.

The present embodiments provide an efficient way to increase the effectiveness of TV advertising through smoother transitions out of the TV broadcaster's programs. The embodiments could be implemented entirely within the STB itself by making use of co-location of the core components that are the splicer and decoders by setting up an additional control mechanism triggered by the cue-in and cue-out splice points in the received transport stream. It is also possible to have a headend or server implementation where all steps except the final adjustment is performed outside of the STB. Regardless of implementation site, the embodiments achieve a smooth transition between video programs and video inserts by controlling brightness and optionally loudness in an efficient and possibly automatic manner.

A further aspect of the embodiments relates to a video insert control device. The video insert control device is configured to determine a program brightness metric of a video program. The program brightness metric represents a current brightness of the video program. The video insert control device is also configured to determine an insert brightness metric of a video insert. The insert brightness metric represents a current brightness of the video insert to be spliced into the video program during an ongoing video session. The video insert control device is further configured to decide whether to adjust brightness of at least an initial portion of decoded pictures of the video insert based on the program brightness metric and the insert brightness metric.

In an embodiment, the video insert control device is configured to update the program brightness metric based on a current picture of the video program. The program brightness metric is a rolling brightness metric representing the current brightness of the video program. The video insert control device is also configured, in this embodiment, to update the insert brightness metric based on a current picture of the video insert. The insert brightness metric is a rolling brightness metric representing the current brightness of the video insert.

In an embodiment, the video insert control device is configured to calculate the program brightness metric Bₑₛₜ^{p}(t) based on Bₑₛₜ^{p}(t)=αₚBₚ(t)+(1−αₚ)Bₑₛₜ^{p}(t−1). The video insert control device is also configured, in this embodiment, to calculate the insert brightness metric Bₑₛₜⁱ(t) based on Bₑₛₜⁱ(t)=αᵢBᵢ(t)+(1−αᵢ)Bₑₛₜⁱ(t−1).

In another embodiment, the video insert control device is configured to calculate the program brightness metric Bₑₛₜ^{p}(t) based on Bₑₛₜ^{p}(t)=max_{k=0 . . . n}_{ₚ}₋₁ (Bₚ(t−k)). The video insert control device is also configured, in this embodiment, to calculate the insert brightness metric Bₑₛₜⁱ(t) based on Bₑₛₜⁱ(t)=max_{k=0 . . . n}_{ᵢ}₋₁(Bᵢ(t−k)).

In an embodiment, the video insert control device is configured to identify a start of the video insert during the ongoing video session. The video insert control device is also configured, in this embodiment, to initiate determination of said insert brightness metric at said start of said video insert.

In an embodiment, the video insert control device is configured to identify a PTS value of a splice point indicating a cue-out splice event in a splice information table.

In a particular embodiment, the video insert control device is configured to update the program brightness metric based on a picture having a PTS value lower than the PTS value of the splice point. The video insert control device is also configured, in this particular embodiment, to update the insert brightness metric based on a picture having a PTS value equal to or higher than the PTS value of the splice point.

In another particular embodiment, the video insert control device is configured to identify a PTS value of a splice point indicating a cue-in splice event in the splice information table. The video insert control device is also configured, in this particular embodiment, to reset the program brightness metric based on the PTS value of the splice point indicating the cue-in splice event and reset the insert brightness metric based on the PTS value of the splice point indicating the cue-in splice event.

In an embodiment, the video insert control device is further configured, in this particular embodiment, to update the program brightness metric based on a picture having a PTS value equal to or higher than the PTS value of the splice point indicating the cue-in splice event.

In an embodiment, the video insert control device is configured to generate brightness control data based on the program brightness metric and the insert brightness metric. The video insert control device is also configured, in this embodiment, to adjust brightness of at least the initial portion of decoded pictures of the video insert based on the brightness control data.

In a particular embodiment, the video insert control device is configured to adjust the brightness of all decoded pictures of the video insert based on the brightness control data.

In another particular embodiment, the video insert control device is configured to adjust, with a gradually declining brightness adjustment, the brightness of at least the initial portion of decoded pictures the video insert based on the brightness control data.

In an embodiment, the video insert control device is configured to compare a difference between the program brightness metric and the insert brightness metric with a threshold value. The video insert control device is also configured, in this embodiment, to adjust brightness of at least the initial portion of decoded pictures of the video insert if the difference is equal to or exceeds the threshold value and otherwise deciding not to adjust brightness of at least the initial portion of decoded pictures of the video insert.

In a particular embodiment, the video insert control device is configured to adjust brightness of at least the initial portion of decoded pictures of the video insert based on a value derived from the program brightness metric, the insert brightness metric and the threshold value.

In another particular embodiment, the video insert control device is configured to adjust the brightness of at least the initial portion of the decoded pictures of the video insert based on a value equal to a difference between the difference between the program brightness metric and the insert brightness metric and the threshold value.

In an embodiment, the video insert control device is configured to determine a program loudness metric of the video program. The loudness brightness metric represents a current loudness of the video program. The video insert control device is also configured, in this embodiment, to determine an insert loudness metric of the video insert. The insert loudness metric represents a current loudness of the video insert. The video insert control device is further configured, in this embodiment, to decide whether to adjust loudness of at least an initial portion of decoded audio frames of the video insert based on the program loudness metric and the insert loudness metric.

In an embodiment, the video insert control device is configured to estimate respective average brightness of decoded pictures of the video program and estimate respective average brightness of decoded pictures of the video insert. The video insert control device is also configured, in this embodiment, to determine the program brightness metric based on the respective average brightness of decoded pictures of the video program and determine the insert brightness metric based on the respective average brightness of decoded pictures of the video insert.

In an embodiment, the video insert control device is configured to estimate respective average brightness of uncompressed pictures of the video program and to estimate respective average brightness of uncompressed pictures of the video insert. The video insert control device is also configured, in this embodiment, to determine the program brightness metric based on the respective average brightness of uncompressed pictures of the video program and to determine the insert brightness metric based on the respective average brightness of uncompressed pictures of the video insert. The video insert control device is further configured, in this embodiment, to generate brightness control data based on the program brightness metric and the insert brightness metric and to insert the brightness control data in a bitstream comprising encoded pictures of the video program and encoded pictures of the video insert.

It will be appreciated that the methods, method steps and devices, device functions described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g., by reprogramming of the existing software or by adding new software components.

FIG. 16 is a schematic block diagram illustrating an example of a video insert control device 100 based on a processor-memory implementation according to an embodiment. In this particular example, the video insert control device 100 comprises a processor 101, such as processing circuitry, and a memory 102. The memory 102 comprises instructions executable by the processor 101.

In an embodiment, the processor 101 is operative to determine the program brightness metric of the video program and to determine the insert brightness metric of the video insert. The processor 101 is also operative to decide whether to adjust brightness of at least the initial portion of decoded pictures of the video insert.

Optionally, the video insert control device 100 may also include a communication circuit, represented by an input/output (I/O) unit 103 in FIG. 16. The I/O unit 103 may include functions for wired and/or wireless communication with other devices and/or network nodes in a wired or wireless communication network.

In a particular example, the I/O unit 103 may be based on radio circuitry for communication with one or more other nodes, including transmitting and/or receiving information. The I/O unit 103 may be interconnected to the processor 101 and/or memory 102. By way of example, the I/O unit 103 may include any of the following: a receiver, a transmitter, a transceiver, I/O circuitry, input port(s) and/or output port(s).

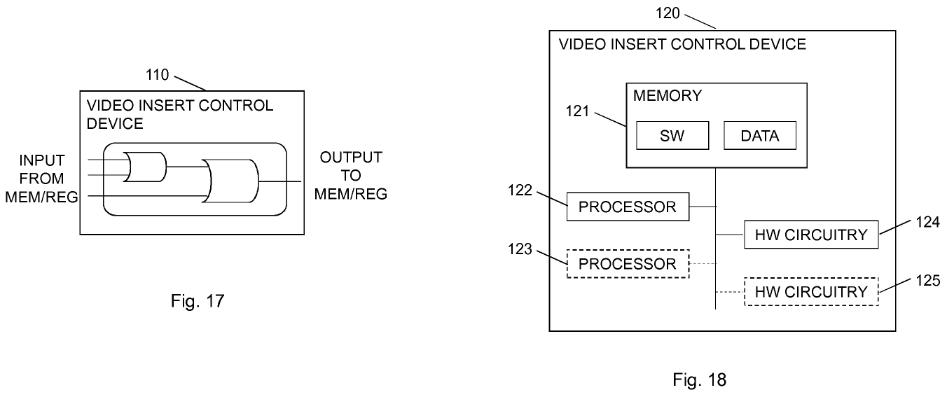

FIG. 17 is a schematic block diagram illustrating another example of a video insert control device 110 based on a hardware circuitry implementation according to an embodiment. Particular examples of suitable hardware circuitry include one or more suitably configured or possibly reconfigurable electronic circuitry, e.g., Application Specific Integrated Circuits (ASICs), FPGAs, or any other hardware logic such as circuits based on discrete logic gates and/or flip-flops interconnected to perform specialized functions in connection with suitable registers (REG), and/or memory units (MEM).

FIG. 18 is a schematic block diagram illustrating yet another example of a video insert control device 120 based on combination of both processor(s) 122, 123 and hardware circuitry 124, 125 in connection with suitable memory unit(s) 121. The video insert control device 120 comprises one or more processors 122, 123, memory 121 including storage for software (SW) and data, and one or more units of hardware circuitry 124, 125. The overall functionality is thus partitioned between programmed software for execution on one or more processors 122, 123, and one or more pre-configured or possibly reconfigurable hardware circuits 124, 125. The actual hardware-software partitioning can be decided by a system designer based on a number of factors including processing speed, cost of implementation and other requirements.

FIG. 20 is a schematic diagram illustrating an example of a video insert control device 200 according to an embodiment. In this particular example, at least some of the steps, functions, procedures, modules and/or blocks described herein are implemented in a computer program 240, which is loaded into the memory 220 for execution by processing circuitry including one or more processors 210. The processor(s) 210 and memory 220 are interconnected to each other to enable normal software execution. An optional I/O unit 230 may also be interconnected to the processor(s) 210 and/or the memory 220 to enable input and/or output of relevant data, such as bitstream or transport stream.

The term ‘processor’ should be interpreted in a general sense as any circuitry, system or device capable of executing program code or computer program instructions to perform a particular processing, determining or computing task.

The processing circuitry including one or more processors 210 is thus configured to perform, when executing the computer program 240, well-defined processing tasks such as those described herein.

The processing circuitry does not have to be dedicated to only execute the above-described steps, functions, procedure and/or blocks, but may also execute other tasks.

In a particular embodiment, the computer program 240 comprises instructions, which when executed by at least one processor 210, cause the at least one processor 210 to determine a program brightness metric of a video program. The program brightness metric represents a current brightness of the video program. The at least one processor 210 is also caused to determine an insert brightness metric of a video insert. The insert brightness metric represents a current brightness of the video insert to be spliced into the video program during an ongoing video session. The at least one processor 210 is further caused to decide whether to adjust brightness of at least an initial portion of decoded pictures of the video insert based on the program brightness metric and the insert brightness metric.

In another particular embodiment, the computer program 240 comprises instructions, which when executed by at least one processor 210, cause the at least one processor 210 to retrieve, from a received bitstream comprising encoded pictures of a video program and encoded pictures of a video insert and for at least an initial portion of encoded pictures of the video insert, brightness control data representing a brightness adjustment. The at least one processor 210 is also caused to decode encoded pictures of the video program and encoded pictures of the video insert. The at least one processor 210 is further caused to adjust a brightness of at least an initial portion of decoded pictures of the video insert based on the brightness control data.

The proposed technology also provides a carrier 250 comprising the computer program 240. The carrier 250 is one of an electronic signal, an optical signal, an electromagnetic signal, a magnetic signal, an electric signal, a radio signal, a microwave signal, or a computer-readable storage medium.

By way of example, the software or computer program 240 may be realized as a computer program product, which is normally carried or stored on a computer-readable medium 250, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program 240 may thus be loaded into the operating memory 220 of a video insert control device 200 for execution by the processing circuitry 210 thereof.

The flow diagram or diagrams presented herein may be regarded as a computer flow diagram or diagrams, when performed by one or more processors. A corresponding video insert control device may be defined as a group of function modules, where each step performed by the processor corresponds to a function module. In this case, the function modules are implemented as a computer program running on the processor.

The computer program residing in memory may, thus, be organized as appropriate function modules configured to perform, when executed by the processor, at least part of the steps and/or tasks described herein.

FIG. 20 is a schematic block diagram of a video insert control device 130 according to an embodiment. The video insert control device 130 comprises a program metric determining module 131 for determining a program brightness metric of a video program. The program brightness metric represents a current brightness of the video program. The video insert control device 130 also comprises an insert metric determining module 132 for determining an insert brightness metric of a video insert. The insert brightness metric represents a current brightness of the video insert to be spliced into the video program during an ongoing video session. The video insert control device 130 further comprises a deciding module 133 for deciding whether to adjust brightness of at least an initial portion of decoded pictures of the video insert based on the program brightness metric and the insert brightness metric.

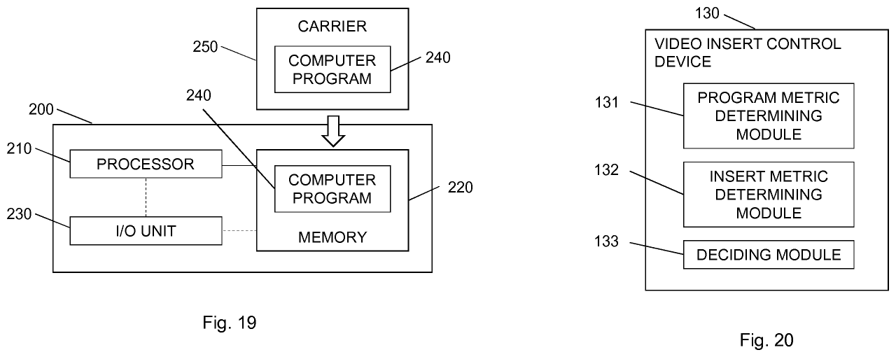

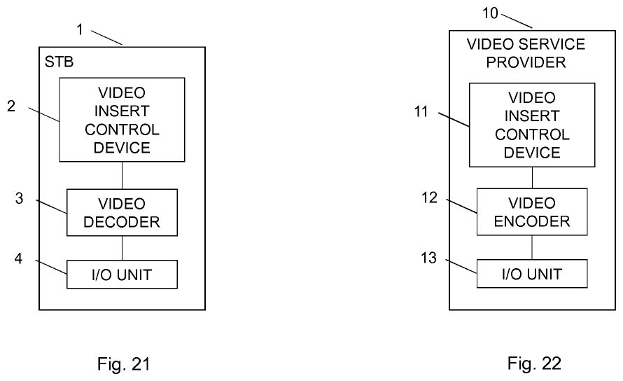

A further aspect of the embodiments relates to an STB 1 as shown in FIG. 21. The STB 1 comprises a video decoder 3 configured to decode a bitstream comprising encoded pictures of a video program and encoded pictures of a video insert. The STB 1 also comprises a video insert control device 2 according to the embodiments, such as described in the foregoing in connection with any of FIGS. 11, 16-20.

The STB 1 optionally also comprises an I/O unit 4 interconnected to the video decoder 3 and/or the video insert control device 2 to enable input and/or output of relevant data, such as bitstream or transport stream.

Yet another aspect of the embodiments relates to a video service provider 10 as shown in FIG. 22. The video service provider 10 comprises a video encoder 12 configured to encode pictures of a video program and encode pictures of a video insert to be spliced into the video program during an ongoing video session. The video service provider 10 also comprises a video insert control device 11 according to the embodiments, such as described in the foregoing in connection with any of FIGS. 15-20.

The video service provider 10 optionally also comprises an I/O unit 13 interconnected to the video encoder 12 and/or the video insert control device 11 to enable input and/or output of relevant data, such as uncompressed video and bitstream or transport stream comprising brightness control data.

A further aspect of the embodiments relates to an STB 1 as shown in FIG. 15. The STB 1 comprises a video decoder 3 configured to retrieve, from a received bitstream comprising encoded pictures of a video program and encoded pictures of a video insert and for at least an initial portion of encoded pictures of the video insert, brightness control data representing a brightness adjustment and decode encoded pictures of the video program and encoded pictures of the video insert. The STB 1 also comprises a brightness controller 23 configured to adjust a brightness of at least an initial portion of decoded pictures of the video insert based on the brightness control data.

It is becoming increasingly popular to provide computing services, hardware and/or software, in network devices, such as network nodes and/or servers, where the resources are delivered as a service to remote locations over a network. By way of example, this means that functionality, as described herein, can be distributed or re-located to one or more separate physical nodes or servers. This applies in particular to the network- or server-implemented video insert control device as shown in FIG. 15 and the video service provider as shown in FIG. 22. The functionality may be re-located or distributed to one or more jointly acting physical and/or virtual machines that can be positioned in separate physical node(s), i.e., in the so-called cloud. This is sometimes also referred to as cloud computing, which is a model for enabling ubiquitous on-demand network access to a pool of configurable computing resources such as networks, servers, storage, applications and general or customized services.

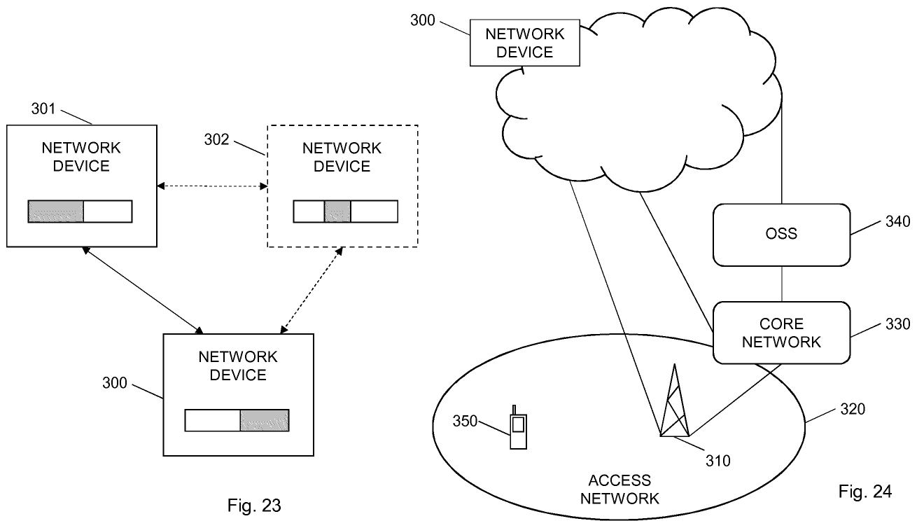

FIG. 23 is a schematic diagram illustrating an example of how functionality can be distributed or partitioned between different network devices or equipment in a general case. In this example, there are at least two individual, but interconnected network devices 300, 301, which may have different functionalities, or parts of the same functionality, partitioned between the network devices 300, 301. There may be additional network devices 302 being part of such a distributed implementation. The network devices 300, 301, 302 may be part of the same wireless or wired communication system, or one or more of the network devices may be so-called cloud-based network devices located outside of the wireless or wired communication system.

FIG. 24 is a schematic diagram illustrating an example of a wireless communication network or system, including an access network 320 and a core network 330 and optionally an operations and support system (OSS) 340 in cooperation with one or more cloud-based network devices 300. The figure also illustrates a user device 350 connected to the access network 320 and capable of conducting wireless communication with a base station representing an embodiment of a network node 310.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A video insert control method comprising:
determining a program brightness metric of a video program, said program brightness metric representing a current brightness of said video program;
determining an insert brightness metric of a video insert, said insert brightness metric representing a current brightness of said video insert to be spliced into said video program during an ongoing video session;
deciding whether to adjust brightness of at least an initial portion of decoded pictures of said video insert based on said program brightness metric and said insert brightness metric, wherein
determining said program brightness metric comprise calculating said program brightness metric Bₑₛₜ^{p}(t) based on Bₑₛₜ^{p}(t)=αₚBₚ (t)+(1−αₚ)Bₑₛₜ^{p}(t−1), wherein αₚ is a smoothing factor that depends on a picture rate rₚ of said video program and a time constant τₚ, and Bₚ(t) is a brightness representing parameter of a current program and said video program; and
determining (S2) said insert brightness metric comprises calculating (S2) said insert brightness metric Bₑₛₜⁱ(t) based on Bₑₛₜⁱ(t)=αᵢBᵢ(t)+(1−αᵢ)Bₑₛₜⁱ(t−1), wherein αᵢ is a smoothing factor that depends on a picture rate rᵢ of said video insert and a time constant τᵢ, and Bᵢ(t) is a brightness representing parameter of a current picture of said video insert, wherein τᵢ≤τₚ.

2. (canceled)

3. (canceled)

4. The video insert control method according to claim 1, wherein α_p=1−e\hat{ }(−1/(r_p τ_p)) and α_i=1−e\hat{ }(−1/(r_i τ_i)).

5. (canceled)

6. (canceled)

7. The video insert control method according to claim 1, wherein τ_i<τ_p.

8.-21. (canceled)

22. A video insert control device, wherein said video insert control device comprises:
a processor; and
a memory comprising instruction executable by said processor, wherein said processor is operative to
determine a program brightness metric of a video program, said program brightness metric representing a current brightness of said video program;
determine an insert brightness metric of a video insert, said insert brightness metric representing a current brightness of said video insert to be spliced into said video program during an ongoing video session; and
decide whether to adjust brightness of at least an initial portion of decoded pictures of said video insert based on said program brightness metric and said insert brightness metric;
calculate said program brightness metric Bₑₛₜ^{p}(t) based on Bₑₛₜ^{p}(t)=αₚBₚ(t)+(1−αₚ)Bₑₛₜ^{p}(t−1), wherein αₚ is a smoothing factor that depends on a picture rate rₚ of said video program and a time constant τₚ, and Bₚ(t) is a brightness representing parameter of a current picture of said video program; and
calculate said insert brightness metric Bₑₛₜⁱ(t) based on Bₑₛₜⁱ(t)=αᵢBᵢ(t)+(1−αᵢ)Bₑₛₜⁱ(t−1), wherein αᵢ is a smoothing factor that depends on a picture rate rᵢ of said video insert and a time constant τᵢ, and Bᵢ(t) is a brightness representing parameter of a current picture of said video insert, wherein τᵢ≤τₚ.

23. The video insert control device according to claim 22, wherein said processor is operative to
update said program brightness metric based on a current picture of said video program, said program brightness metric is a rolling brightness metric representing said current brightness of said video program; and
update said insert brightness metric based on a current picture of said video insert, said insert brightness metric is a rolling brightness metric representing said current brightness of said video insert.

24.-25. (canceled)

26. The video insert control device according to claim 22, wherein said processor is operative to:
identify a start of said video insert during said ongoing video session; and
initiate determination of said insert brightness metric at said start of said video insert.

27. The video insert control device according to claim 26, wherein said processor is operative to identify a presentation time stamp (PTS) value of a splice point indicating a cue-out splice event in a splice information table.

28. The video insert control device according to claim 27, wherein said processor is operative to
update said program brightness metric based on a picture having a PTS value lower than said PTS value of said splice point indicating said cue-out splice event; and
update said insert brightness metric based on a picture having a PTS value equal to or higher than said PTS value of said splice point indicating said cue-out splice event.

29. The video insert control device according to claim 27, wherein said processor is operative to
identify a PTS value of splice point indicating a cue-in splice event in said splice information table;
reset said program brightness metric based on said PTS value of said splice point indicating said cue-in splice event; and
reset said insert brightness metric based on said PTS value of said splice point indicating said cue-in splice event.

30. The video insert control device according to claim 29, wherein said processor is operative to update said program brightness metric based on a picture having a PTS value equal to or higher than said PTS value of said splice point indicating said cue-in splice event.

31. The video insert control device according to claim 22, wherein said processor is operative to
generate brightness control data based on said program brightness metric and said insert brightness metric; and
adjust brightness of at least said initial portion of decoded pictures of said video insert based on said brightness control data.

32. The video insert control device according to claim 31, wherein said processor is operative to adjust said brightness of all decoded pictures of said video insert based on said brightness control data.

33. The video insert control device according to claim 31, wherein said processor is operative to adjust, with a gradually declining brightness adjustment, said brightness of at least said initial portion of decoded pictures said video insert based on said brightness control data.

34. The video insert control device according to claim 22, wherein said processor is operative to
compare a difference between said program brightness metric and said insert brightness metric with a threshold value; and
adjust brightness of at least said initial portion of decoded pictures of said video insert if said difference is equal to or exceeds said threshold value and otherwise deciding not to adjust brightness of at least said initial portion of decoded pictures of said video insert.

35. The video insert control device according to claim 34, wherein said processor is operative to adjust brightness of at least said initial portion of decoded pictures of said video insert based on a value derived from said program brightness metric, said insert brightness metric and said threshold value.

36. The video insert control device according to claim 35, wherein said processor is operative to adjust said brightness of at least said initial portion of said decoded pictures of said video insert based on a value equal to a difference between said difference between said program brightness metric and said insert brightness metric and said threshold value.

37. The video insert control device according to claim 22, wherein said processor is operative to
estimate respective average brightness of decoded pictures of said video program;
estimate respective average brightness of decoded pictures of said video insert;
determine said program brightness metric based on said respective average brightness of decoded pictures of said video program; and
determine said insert brightness metric based on said respective average brightness of decoded pictures of said video insert.

38. The video insert control device according to claim 22, wherein said processor is operative to
estimate respective average brightness of uncompressed pictures of said video program;
estimate respective average brightness of uncompressed pictures of said video insert;
determine said program brightness metric based on said respective average brightness of uncompressed pictures of said video program;
determine said insert brightness metric based on said respective average brightness of uncompressed pictures of said video insert;
generate brightness control data based on said program brightness metric and said insert brightness metric; and
insert said brightness control data in a bitstream comprising encoded pictures of said video program and encoded pictures of said video insert.

39. (canceled)

40. (canceled)

41. A set-top box comprising:
a video decoder configured to decode a bitstream comprising encoded pictures of a video program and encoded pictures of a video insert; and
a video insert control device according to claim 22.

42. A video service provider comprising:
a video encoder configured to encode pictures of a video program and encode pictures of a video inset to be spliced into said video program during an ongoing video session; and
a video insert control device according to claim 22.

43-46. (canceled)
